(19) United States
(12) Patent Application Publication
(10) Pub. No.: US 2023/0338920 A1
(43) Pub. Date: Oct. 26, 2023

(54) Perovskite Oxygen Carriers and Methods for Making and Using Perovskite Oxygen Carriers

(71) Applicant: United States Department of Energy, Washington, DC (US)

(72) Inventors: Jonathan Lekse, Pittsburgh, PA (US); Christopher Marin, Pittsburgh, PA (US); Eric Popczun, Castle Shannon, PA (US); Sittichai Natesakhawat, Bridgeville, PA (US)

(21) Appl. No.: 18/137,768

(22) Filed: Apr. 21, 2023

Related U.S. Application Data
(60) Provisional application No. 63/333,889, filed on Apr. 22, 2022.

(51) Int. Cl. B01J 20/04; B01D 53/04

(52) U.S. Cl. CPC B01J 20/041; B01D 53/0462; B01D 2253/1124; B01D 2257/104; B01D 2259/40007; B01D 2259/40088

(57) ABSTRACT

A perovskite oxygen carrier having the formula Sr₁₋ₓCaₓFe_{1-y}Ni_{y}O₃, where 0.05<x<0.30 and 0.001<y<0.125 and a method of using the perovskite carrier to carry oxygen. A mesoporous perovskite oxygen carrier having the formula Sr₁₋ₓCaₓFeO₃, where 0.01<x<0.40 and methods for making and using the mesoporous perovskite oxygen carrier.

### CROSS REFERENCE TO RELATED APPLICATIONS

This Utility Patent Application claims priority benefit as a U.S. Non-Provisional of U.S. Provisional Patent Application Ser. No. 63/333,889, filed on Apr. 22, 2022, currently pending, the entirety of which is incorporated by reference herein.

### GOVERNMENT INTERESTS

This invention was made with United States Government support under the Department of Energy Number DE-FE0004000. The United States Government has certain rights in this invention.

### FIELD OF THE INVENTION

Exemplary embodiments relate to perovskite oxygen carriers and methods for making same. More specifically, exemplary embodiments relate to B-site doped perovskite oxygen carriers and methods for using same. Still other exemplary embodiments relate to mesoporous perovskite oxygen carriers, methods for using same, and methods for making same.

### BACKGROUND OF THE INVENTION

Pure oxygen is an important commodity in the present day. Uses include, but are not limited to, medical needs, wastewater treatment, fuel cell technology, as well as coal-fired combustion plants in order to ease carbon dioxide capture, and reduce emissions. Currently there are a few methods to separate oxygen from an air stream, including cryogenics, but most are too expensive to perform on a large scale.

One economically viable alternative is chemical looping air separation systems that rely on a difference in the partial pressure of oxygen gas to activate an oxygen carrier that will selectively uptake oxygen from a higher partial pressure and release adsorbed oxygen at a lower partial pressures. As an example, an air stream is 21% oxygen whereas an inert gas stream, like nitrogen or argon, is 0% oxygen.

Most oxygen carriers can complete both halves of this process at high temperatures (673° K.-1273° K.) but factors of increased cost of materials, the need for high temperatures, and rate of oxygen release are pertinent. Each of these factors can directly limit the economic viability and profitability of the process.

There is a need in the art for oxygen carriers that overcome the disadvantages of the prior art that provide superior value, improved kinetics, higher activity at lower temperatures, and reduced or no use of high-demand and/or expensive elements such as platinum or cobalt.

Perovskite oxides of the ABO₃ form are among the most commonly studied oxygen storage materials given their robust stability through the uptake/release process. The presence of oxygen vacancies in a typical perovskite carrier allows for easy oxygen transport and its reduction only requires a slight rearrangement of atoms. As such, perovskites are efficient oxygen carriers due to rapid oxygen uptake/release at reasonably low operating temperatures while other oxygen carriers require higher temperatures and more elaborate structural changes.

### SUMMARY

An embodiment of the invention provides perovskite oxygen carriers featuring a B-site doped with Ni and methods of using said perovskite oxygen carriers B-site doped with Ni to carry oxygen.

Further embodiments of the invention provide mesoporous perovskite oxygen carriers, methods of making said mesoporous perovskite oxygen carriers, and methods of using said mesoporous perovskite oxygen carriers to carry oxygen.

Briefly the invention provides a perovskite oxygen carrier comprising the formula SrFeO₃, wherein the oxygen carrier comprises an A-site and a B-Site, and wherein the B-site is doped with Ni.

The invention also provides a perovskite oxygen carrier comprising the formula Sr₁₋ₓCaₓFe_{1-y}Ni_{y}O₃, where 0.05<x<0.30 and 0.001<y<0.125.

The invention still further provides a method for carrying oxygen using a perovskite oxygen carrier, the method comprising: providing a reduced oxygen carrier to a reaction environment; contacting the reduced oxygen carrier with an oxygen containing gaseous stream for a predetermined time at a first temperature and a first oxygen partial pressure, wherein the reduced oxygen carrier adsorbs oxygen from the gaseous stream during this step, giving an oxygen carrier; and heating the oxygen carrier to a second temperature at a second oxygen partial pressure, causing oxygen adsorbed onto the oxygen carrier in the contacting step to be released from the oxygen carrier, reforming the reduced oxygen carrier, wherein the oxygen carrier comprises the formula Sr₁₋ₓCaₓFe_{1-y}Ni_{y}O₃, where 0.05<x<0.30 and 0.001<y<0.125.

The invention also provides a perovskite oxygen carrier comprising the formula SrCaFeO₃, wherein the is mesoporous.

The invention still further provides a method for carrying oxygen using a perovskite oxygen carrier, the method comprising: providing a reduced oxygen carrier to a reaction environment; contacting the reduced oxygen carrier with an oxygen containing gaseous stream for a predetermined time at a first temperature and a first oxygen partial pressure, wherein the reduced oxygen carrier adsorbs oxygen from the gaseous stream during this step, giving an oxygen carrier; and heating the oxygen carrier to a second temperature at a second oxygen partial pressure, causing oxygen adsorbed onto the oxygen carrier in the contacting step to be released from the oxygen carrier, reforming the reduced oxygen carrier, wherein the oxygen carrier comprises the formula Sr₁₋ₓCaₓFeO₃, where 0.01<x<0.40, and wherein said oxygen carrier is mesoporous.

The invention still further provides a method for making mesoporous perovskite oxygen carriers comprising: producing polymerized metal-carboxylate chelates; calcining the polymerized metal-carboxylate chelates at a synthesis temperature to produce the mesoporous perovskite oxygen carriers, wherein the synthesis temperature is below 1000° C.

### BRIEF DESCRIPTION OF THE DRAWINGS

Embodiments of the present invention are illustrated in the accompanying figures where:

FIG. 1 depicts a generic formula for a B-site doped perovskite Oxygen carrier, in accordance with the features of the present invention;

FIG. 2 is a schematic of a method to use a B-site doped perovskite oxygen carrier to selectively adsorb oxygen from a gaseous stream and release said oxygen at a later time, in accordance with the features of the present invention;

FIG. 3 depicts the optimized crystal sructure of Sr₁₋ₓCaₓFe_{1-y}Ni_{y}O₃ (x=0.1875, 0.25, 0.3125, y=0, 0.0625) with various Ca A-site doping configurations and various Ni B-site configurations, in accordance with the features of the present invention;

FIGS. 4A-4C depict X-ray diffraction patterns for Sr₁₋ₓCaₓFe_{1-y}Ni_{y}O₃ materials, wherein x=0.20 for the X-Ray diffraction pattern shown FIG. 4A, x=0.25 for the X-Ray diffraction pattern shown in FIG. 4B, and x=0.30 for the X-Ray diffraction pattern shown in FIG. 4C, in accordance with the features of the present invention;

FIG. 5 is a plot of Synchrotron pXRD patterns for the oxygen carrier Sr_{0.75}Ca_{0.25}Fe_{1-y}Ni_{y}O₃ (y=0, 0.06, 0.12) at room temperature, in accordance with the features of the present invention;

FIG. 6A is a scanning electron microscopy image for the oxygen carrier Sr_{0.75}Ca_{0.25}Fe_{1-y}Ni_{y}O₃ where y=0, in accordance with the features of the present invention;

FIG. 6B is an energy dispersive X-ray spectroscopy elemental mapping for Sr_{0.75}Ca_{0.25}Fe_{1-y}Ni_{y}O₃ where y=0, in accordance with the features of the present invention;

FIG. 6C is a scanning electron microscopy image for the oxygen carrier Sr_{0.75}Ca_{0.25}Fe_{1-y}Ni_{y}O₃ where y=0.06, in accordance with the features of the present invention;

FIG. 6D is an energy dispersive X-ray spectroscopy elemental mapping for Sr_{0.75}Ca_{0.25}Fe_{1-y}Ni_{y}O₃ where y=0.06, in accordance with the features of the present invention;

FIG. 6E is a scanning electron microscopy image for the oxygen carrier Sr_{0.75}Ca_{0.25}Fe_{1-y}Ni_{y}O₃ where y=0.12, in accordance with the features of the present invention;

FIG. 6F is an energy dispersive X-ray spectroscopy elemental mapping for Sr_{0.75}Ca_{0.25}Fe_{1-y}Ni_{y}O₃ where y=0.12, in accordance with the features of the present invention;

FIGS. 7A-7C provide O₂-TPD traces for Sr₁₋ₓCaₓFe_{1-y}Ni_{y}O₃ oxygen carriers, wherein x=0.20 for the O₂-TPD trace shown in FIG. 7A, x=0.25 for the O₂-TPD trace shown in FIG. 7B, and x=0.30 for the O₂-TPD trace shown in FIG. 7C, in accordance with the features of the present invention;

FIGS. 8A-8C show TGA traces for previously reduced Sr₁₋ₓCaₓFe_{1-y}Ni_{y}O₃ oxygen carrier samples heated in air to observe oxygen adsorption thermodynamics, wherein FIG. 8A shows TGA traces for previously reduced Sr_{0.8}Ca_{0.2}Fe_{1-y}Ni_{y}O₃, FIG. 8B shows TGA traces for previously reduced Sr_{0.75}Ca_{0.25}Fe_{1-y}Ni_{y}O₃, and FIG. 8C shows TGA traces for previously reduced Sr_{0.7}Ca_{0.3}Fe_{1-y}Ni_{y}O₃; in accordance with the features of the present invention;

FIGS. 9A-9C show TGA traces from Air/N₂ cycling experiments on Sr_{0.8}Ca_{0.2}Fe_{1-y}Ni_{y}O₃ oxygen carrier samples at 400° C. for the traces shown in FIG. 9A, at 450° C. for the traces shown in FIG. 9B, and at 500° C. for the traces shown in FIG. 9C, in accordance with the features of the present invention;

FIGS. 10A-10B show TGA traces from Air/N₂ cycling experiments on Sr_{0.75}Ca_{0.25}Fe_{1-y}Ni_{y}O₃ oxygen carrier samples at 400° C. for the traces shown in FIG. 10A and at 450° C. for traces shown in FIG. 10B, in accordance with the features shown in the present invention;

FIGS. 11A-11B show TGA traces from air/nitrogen cycling experiments on Sr_{0.7}Ca_{0.3}Fe_{1-y}Ni_{y}O₃ samples at 400° C. for the traces shown in FIG. 11A and at 450° C. for the traces shown in FIG. 11B, in accordance with the features of the present invention;

FIGS. 12A-12C show TGA traces for Sr_{0.8}Ca_{0.2}Fe_{1-y}Ni_{y}O₃ oxygen carrier samples for Air/N₂ cycling experiments at 400° C. for the traces shown in FIG. 12A, at 450° C. for the traces shown in FIG. 12B, and at 500° C. for the traces shown in FIG. 12C, in accordance with the features of the present invention;

FIGS. 13A-13B shows TGA traces from Air/N₂ cycling experiments on Sr_{0.75}Ca_{0.25}Fe_{1-y}Ni_{y}O₃ oxygen carrier samples at 400° C. for the traces shown in FIG. 13A and at 450° C. for traces shown in FIG. 13B, in accordance with the features shown in the present invention;

FIGS. 14A-14B shows TGA traces from Air/N₂ cycling experiments on Sr_{0.7}Ca_{0.3}Fe_{1-y}Ni_{y}O₃ oxygen carrier samples at 400° C. for the traces shown in FIG. 14A and at 450° C. for traces shown in FIG. 14B, in accordance with the features shown in the present invention;

FIG. 15 provides O₂-TPD traces for Sr_{0.75}Ca_{0.25}FeO₃, Sr_{0.75}Ca_{0.25}Fe0.94Ni_{0.06}O₃, and Sr_{0.75}Ca_{0.25}Fe_{0.88}Ni_{0.12}O₃, in accordance with the features of the present invention;

FIG. 16 provides TGA traces for previously reduced Sr_{0.75}Ca_{0.25}FeO₃, Sr_{0.75}Ca_{0.25}Fe_{0.94}Ni_{0.06}O₃, and Sr_{0.75}Ca_{0.25}Fe_{0.88}Ni_{0.12}O₃ samples heated in air, in accordance with the features of the present invention;

FIGS. 17A-17B show TGA traces from air/nitrogen cycling experiments on Sr_{0.7}Ca_{0.3}FeO₃, Sr_{0.7}Ca_{0.3}FeO₃, and Sr_{0.75}Ca_{0.25}Fe_{0.9375}Ni_{0.0625}O₃ samples at 400° C. for the traces shown in FIG. 17A and at 450° C. for the traces shown in FIG. 17B, in accordance with the features of the present invention;

FIG. 18 shows partial density of states plots of Sr₁₋ₓCaₓFe_{1-y}Ni_{y}O₃ (x=0.1875, 0.25, 0.3125, y=0.0625), compared with the partial density of states of Sr_{0.8125}Ca_{0.1875}FeO₃, in accordance with the features of the present invention;

FIG. 19A shows a plot of formation energies E_{f} as a function of Ca content x for Sr₁₋ₓCaₓFe_{1-y}Ni_{y}O₃ (x=0.1875, 0.25, 0.3125, y=0, 0.0625), in accordance with the features of the present invention;

FIG. 19B shows a plot of bond energies Ebond as a function of Ca content x for Sr₁₋ₓCaₓFe_{1-y}Ni_{y}O₃ (x=0.1875, 0.25, 0.3125, y=0, 0.0625), in accordance with the features of the present invention;

FIG. 19C shows a plot of structural relaxation energies Erelax as a function of Ca content x for Sr₁₋ₓCaₓFe_{1-y}Ni_{y}O₃ (x=0.1875, 0.25, 0.3125, y=0, 0.0625), in accordance with the features of the present invention;

FIG. 20A is an electron microscopy image of a mesoporous perovskite oxygen carrier as-made, in accordance with the features of the present invention;

FIG. 20B is an electron microscopy image of mesoporous perovskite oxygen carrier after used in testing, in accordancew with the features of the present invention;

FIG. 21A is a schematic for a method for making a mesoprous perovskite oxygen carrier, in accordance with the features of the present invention;

FIG. 21B is a schematic showing the substeps for making polymerized metal-carboxylate chelates on the way to making a mesoporous perovskite oxygen carrier, in accordance with the features of the present invention;

FIGS. 22A-22C provide powder x-ray diffraction patterns for various Sr₁₋ₓCaₓFeO₃ oxygen carriers, in accordance with the features of the present invention;

FIGS. 23A-23G are SEM images of Sr_{0.75}Ca_{0.25}FeO₃ oxygen carriers made according to the invented method illustrated in FIG. 21A, where FIG. 23A is an SEM image of Sr_{0.75}Ca_{0.25}FeO₃ oxygen carrier made at 700° C., FIG. 23B is an SEM image of Sr_{0.75}Ca_{0.25}FeO₃ oxygen carrier made at 750° C., FIG. 23C is an SEM image of Sr_{0.75}Ca_{0.25}FeO₃ oxygen carrier made at 800° C., FIG. 23D is an SEM image of Sr_{0.75}Ca_{0.25}FeO₃ oxygen carrier made at 850° C., FIG. 23E is an SEM image of Sr_{0.75}Ca_{0.25}FeO₃ oxygen carrier made at 900° C., FIG. 23F is an SEM image of Sr_{0.75}Ca_{0.25}FeO₃ oxygen carrier made at 950° C., and FIG. 23G is an SEM image of Sr_{0.75}Ca_{0.25}FeO₃ oxygen carrier made at 1000° C., in accordance with the features of the present invention;

FIG. 23H is a table providing the BET surface area for the Sr_{0.75}Ca_{0.25}FeO₃ oxygen carriers shown in FIGS. 23A-23G, in accordance with the features of the present invention;

FIG. 24 shows CO₂-TPD traces from a mass spectrometer for various samples of Sr_{0.8}Ca_{0.2}FeO₃ oxygen carriers, in accordance with features of the present invention;

FIG. 25 shows O₂-TPD traces of three bulk Sr₁₋ₓCaₓFeO₃ materials, in accordance with the features of the present invention;

FIG. 26 shows TGA adsorption traces of three bulk Sr₁₋ₓCaₓFeO₃ materials, in accordance with the features of the present invention;

FIGS. 27A-27C show isothermal air/N₂ cycling data at different operating temperatures for three bulk Sr₁₋ₓCaₓFeO₃ materials each having a Tₚ=800° C., where the operating temperature was 400° C. for the data shown in FIG. 27A, 450° C. for the data shown in FIG. 27B, and 500° C. for the data shown in FIG. 27C, in accordance with the features of the present invention;

FIGS. 28A-28C shows O₂-TPD traces of various Sr₁₋ₓCaₓFeO₃ materials grouped by their elemental composition, in accordance with the features of the present invention;

FIGS. 29A-29C provide TGA traces resulting from direct oxidation of various Sr₁₋ₓCaₓFeO₃ materials made using the invented method and pretreated at 700° C. in N₂, in accordance with the features of the present invention;

FIGS. 30A-30E provide TGA traces of redox cycles of various Sr_{0.8}Ca_{0.2}FeO₃ materials all pretreated at 700° C., with FIG. 30A showing data using an operating temperature of 350° C., FIG. 30B showing data using an operating temperature of 375° C., FIG. 30C showing data using an operating temperature of 400° C., FIG. 30D showing data using an operating temperature of 450° C., and FIG. 30E showing data using an operating temperature of 500° C., in accordance with the features of the present invention;

FIGS. 31A-31E provide TGA traces of redox cycles in various Sr_{0.75}Ca_{0.25}FeO₃ materials all pretreated at 700° C., with FIG. 31A showing data using an operating temperature of 350° C., FIG. 31B showing data using an operating temperature of 375° C., FIG. 31C showing data using an operating temperature of 400° C., FIG. 31D showing data using an operating temperature of 450° C., and FIG. 31E showing data using an operating temperature of 500° C., in accordance with the features of the present invention;

FIGS. 32A-32E provide TGA traces of redox cycles in various Sr_{0.7}Ca_{0.3}FeO₃ materials all pretreated at 700° C., with FIG. 32A showing data using an operating temperature of 350° C., FIG. 32B showing data using an operating temperature of 375° C., FIG. 32C showing data using an operating temperature of 400° C., FIG. 32D showing data using an operating temperature of 450° C., and FIG. 32E showing data using an operating temperature of 500° C., in accordance with the features of the present invention;

FIGS. 33A-33F provide oxidation profiles of various perovskite oxygen carriers following controlled pretreatment at various temperatures where FIG. 33A shows the oxidation profile of SCF20-1000, FIG. 33B shows the oxidation profile of SCF25-1000, FIG. 33C shows the oxidation profile of SCF30-850, FIG. 33D shows the oxidation profile of SCF20-SSR, FIG. 33E shows the oxidation profile of SCF25-SSR, and FIG. 33F shows the oxidation profile of SCF30-SSR, in accordance with the features of the present invention;

FIG. 34 shows the heating profile for in situ pXRD testing done with Sr₁₋ₓCaₓFeO₃ materials, in accordance with the features of the present invention;

FIG. 35 shows x-ray diffractions patterns of SCF30-SSR collected sequentially at elevated temperatures under air or argon flow, in accordance with the features of the present invention;

FIGS. 36A-36C show plots of the oxygen storage capacity and reduction rate for Sr₁₋ₓCaₓFeO₃ materials at an operating temperature of 400° C. where FIG. 36A shows oxygen storage capacity and reduction rate separated by composition, FIG. 36B shows oxygen storage capacity and reduction rate separated by syntehsis temperature, and FIG. 36C shows separated by shows oxygen storage capacity and reduction rate separated pretreatment temperature, in accordance with the features of the present invention;

FIGS. 37A-37C show plots of the oxygen storage capacity and reduction rate for Sr₁₋ₓCaₓFeO₃ materials at an operating temperature of 450° C. where FIG. 37A shows oxygen storage capacity and reduction rate separated by composition, FIG. 37B shows oxygen storage capacity and reduction rate separated by syntehsis temperature, and FIG. 37C shows separated by shows oxygen storage capacity and reduction rate separated pretreatment temperature, in accordance with the features of the present invention;

FIGS. 38A-38C show plots of the oxygen storage capacity and reduction rate for Sr₁₋ₓCaₓFeO₃ materials at an operating temperature of 500° C. where FIG. 38A shows oxygen storage capacity and reduction rate separated by composition, FIG. 38B shows oxygen storage capacity and reduction rate separated by syntehsis temperature, and FIG. 38C shows separated by shows oxygen storage capacity and reduction rate separated pretreatment temperature, in accordance with the features of the present invention;

FIG. 39 is a plot of oxygen temperature programmed desorption on samples of Sr_{0.8}Ca_{0.2}FeO₃ synthesized at different synthesis temperatures using the method shown in FIG. 21A and a sample made through a bulk solid-state method at 1100° C., in accordance with the features of the present invention;

FIG. 40 is a TGA plot of oxygen uptake versus temperature of bulk and samples of Sr_{0.75}Ca_{0.25}FeO₃ and Sr_{0.7}Ca_{0.3}FeO₃ made according to the method shown in FIG. 21A, in accordance with the features of the present invention;

FIGS. 41A-41B plot the results of a TGA of Oxygen uptake versus temperature of bulk and samples of Sr_{0.75}Ca_{0.25}FeO₃ and Sr_{0.7}Ca_{0.3}FeO₃ made using the invented method, in accordance with the features of the present invention;

FIG. 42 provides a table of average kinetic data for various embodiments of the invented mesoporous perovskite oxygen carrier determined through thermogravimetry at 350° C., 375° C., 400° C., 450° C., and 500° C., in accordance with the features of the present invention; and

FIG. 43 provides a table with the average values for the oxygen storage capacity, reduction rates, and oxidation rates of various samples of the invented mesoporous perovskite oxygen carriers with pretreatment with N₂ at temperatures between 700 and 1000° C., in accordance with the features of the present invention.

### DETAILED DESCRIPTION OF THE INVENTION

The following detailed description provides illustrations for embodiments of the present invention. Each example is provided by way of explanation of the present invention, not in limitation of the present invention. Those skilled in the art will recognize that other embodiments for carrying out or practicing the present invention are also possible. Therefore, it is intended that the present invention covers such modifications and variations as come within the scope of the appended claims and their equivalents.

As used herein, “mesoporous” means a material that is porous, wherein those pores have a diameter between approximately 2 and approximately 50 nm.

As used herein, “bulk materials” are materials wherein all dimensions of said materials are above 100 nm.

As used herein, nanomaterials comprise materials having at least one dimension in the range of 1 to 100 nm.

### B-Site Doped Perovskite Oxygen Carrier Detail

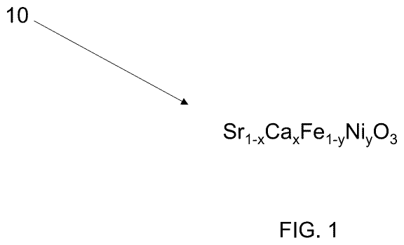

An embodiment of the invention provides a novel perovskite oxygen carrier composition, wherein perovskite comprises a composition of the general formula ABO₃. More specifically, the invention provides a perovskite composition comprising a SrFeO₃ perovskite oxygen carrier wherein the A-site (Sr) of the oxygen carrier is doped with Ca and the B-site (Fe) of the oxygen carrier is doped with Ni. In an embodiment, the invented B-site doped perovskite oxygen carrier 10 as shown in FIG. 1 has the general formula of Sr₁₋ₓCaₓFe_{1-y}Ni_{y}O₃, where 0.05<x<0.30 and 0.001<y<0.125.

A salient feature of embodiments of the invention are that the invented B-site doped perovskite oxygen carrier does not include any of lanthanide elements, cobalt, or platinum.

In an alternative embodiment, the general formula of the invented B-site doped perovskite oxygen carrier is (Sr₁₋ₓCaₓ)_{0.80-1.20}Fe_{1-y}M_{y}O₃, where 0.05<x<0.40, 0.001<y<0.25, and M is selected from the group consisting of scandium, titanium, manganese, nickel, copper, zinc, and a combination thereof.

In yet another alternative embodiment, the general formula of the invented B-site doped perovskite oxygen carrier is (Sr₁₋ₓCaₓ)_{0.80-1.20}Fe_{1-y-z}Co_{y}M_{z}O₃, where 0.05<x<0.40, 0.001<y<0.50, 0.001<z<0.25, and M is selected from the group consisting of scandium, titanium, manganese, nickel, copper, zinc, and a combination thereof.

The invented B-site doped perovskite oxygen carriers 10 can be formulated into any physical form desired by a user. Exemplary forms include monoliths, macroparticles, microparticles, nanoparticles, pellets, rods, and combinations thereof. Additionally, the invented B-site doped perovskite oxygen carriers 10 are suitable for use in various catalytic setups such as chemical loops, packed beds, fluidized beds, etc. and combinations thereof.

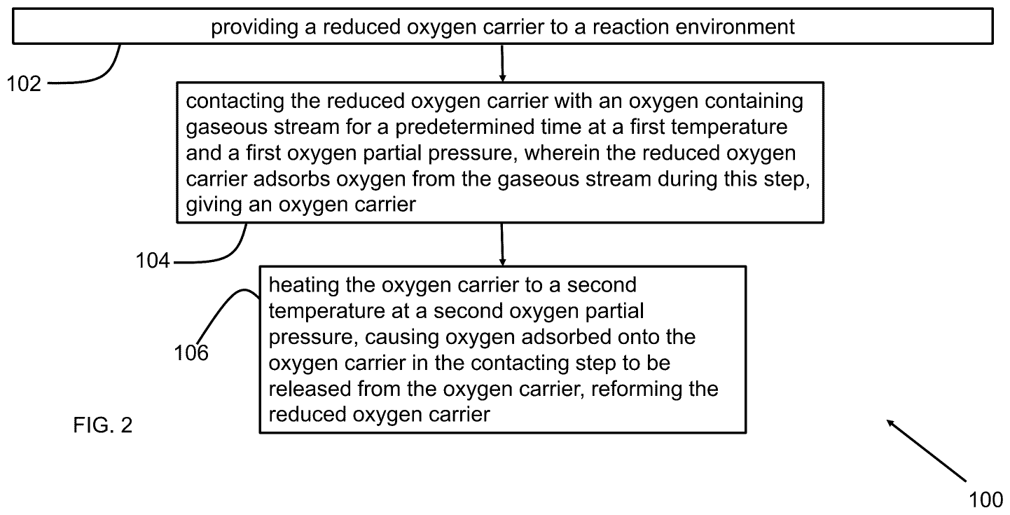

In an embodiment, the invented B-site doped perovskite oxygen carrier is suitable for use in temperature and or pressure swing reactions to selectively adsorb and release oxygen. EQUATION 1 below provides the reactions for such a process where the forward reaction of EQUATION 1 shows the reduction of the invented B-site doped perovskite oxygen carrier, i.e., the oxygen carrier releasing oxygen to form a reduced oxygen carrier. The reverse reaction of EQUATION 1 shows the oxidation of the reduced invented B-site doped perovskite oxygen carrier, i.e. the reduced oxygen carrier adsorbing oxygen to form the invented perovskite oxygen carrier 10. FIG. 2 shows a schematic for a method 100 of using the invented B-site doped perovskite oxygen carrier to carry oxygen, i.e., adsorb oxygen from a gaseous stream and release said oxygen at a later time.

As shown in FIG. 2, the method 100 begins by providing a reduced oxygen carrier to a reaction environment 102, wherein the reduced oxygen carrier is the invented oxygen carrier 10 (or the mesoporous perovskite oxygen carrier discussed below) that has been reduced according to EQUATION 1 above. The invented oxygen carrier can be placed into the reaction area and reduced prior to performance of the invented method or can be reduced in an outside environment before introduction into the reaction environment. In an embodiment, the oxygen carrier is reduced in a step identical to the heating step 106 described below.

Once the reduced oxygen carrier is positioned within the reaction environment, the method continues by contacting the reduced oxygen carrier with an oxygen containing gaseous stream for a predetermined time at a first temperature and a first oxygen partial pressure 104, wherein the reduced oxygen carrier adsorbs oxygen from the gaseous stream during the contacting step 104, forming an oxygen carrier. After the contacting step 104, the method continues by heating the oxygen carrier to a second temperature at a second oxygen partial pressure, causing oxygen adsorbed onto the oxygen carrier in the contacting step to be released, reforming the reduced oxygen carrier 106.

$${Sr}_{1 - x} {Ca}_{x} {Fe}_{1 - y} {Ni}_{y} {O}_{3 - δ ox ↔} {Sr}_{1 - x} {Ca}_{x} {Fe}_{1 - y} {Ni}_{y} {O}_{3 - δ red} + ( \frac{{δ}_{red} - {δ}_{ox}}{2} ) {O}_{2} \qquad EQUATION 1$$

In the first step of the method 100 described above and shown in FIG. 2, the reduced oxygen carrier is contacted with an oxygen containing gaseous stream. Any gas or mixture of gasses that contains oxygen is suitable for use in the method 100 as the oxygen containing gaseous stream.

As described above and shown in FIG. 2, the contacting step 104 is performed for a predetermined time at a first temperature and at a first oxygen partial pressure. Performing the contacting step 104 at a first temperature comprises the reaction environment being the first temperature while the oxygen containing gaseous stream contacts the reduced oxygen carrier and or the oxygen containing gaseous stream is the first temperature while the oxygen containing gaseous stream contacts the reduced oxygen carrier. The first temperature is any temperature where oxygen adsorbs onto the reduced oxygen carrier when said oxygen contacts said reduced oxygen carrier. Preferably the first temperature is between approximately 373° K. and approximately 1173° K., wherein the first temperature is typically between approximately 523° K. and approximately 823° K.

As described above and shown in FIG. 2, the contacting step 104 is performed for a predetermined time at a first temperature and at a first oxygen partial pressure. Performing the contacting step 104 at a first oxygen partial pressure comprises the reaction environment being the first oxygen partial pressure while the oxygen containing gaseous stream contacts the reduced oxygen carrier. The first oxygen partial pressure is any pressure where oxygen adsorbs onto the oxygen carrier when said oxygen contacts said reduced oxygen carrier. Preferably the first oxygen partial pressure is between approximately 0.01 atm and approximately 1 atm, wherein the first oxygen partial pressure is typically between approximately 0.1 atm and approximately 0.25 atm.

A salient feature of the invention is the performance of the invented B-site doped perovskite oxygen carrier when used in a process such as that shown in FIG. 2. In an embodiment, during the contacting step 104, the reduced oxygen carrier adsorbs between approximately 1.50 wt % and approximately 3.00 wt % of oxygen, often called a material's oxygen storage capacity. In embodiment, the reduced oxygen carrier adsorbs at least 2.00 wt % oxygen during the contacting step 104.

Also during the contacting step 104, the invention provides maximum adsorption temperatures, the temperature where the reduced oxygen carrier adsorbs oxygen at the fastest rate, that are superior to the prior art. In an embodiment, the maximum adsorption temperature during the contacting step is between approximately 573° K. and approximately 673° K. using a reduced B-site doped perovskite oxygen carrier.

Still further, during the contacting step, the invention provides improved oxidation rates compared to the prior art. In embodiment, the oxidation rate during the contacting step is between approximately 2 wt %/min and approximately 10 wt %/min when using the invented B-site doped perovskite oxygen carrier.

As described above and shown in FIG. 2, during the heating step 106, the oxygen carrier is heated to a second temperature at a second oxygen partial pressure 106, causing oxygen adsorbed onto the oxygen carrier in the contacting step 104 to be released. Heating the oxygen carrier to a second temperature comprises heating the oxygen carrier and or the surrounding reaction environment to said second temperature. The second temperature is any temperature where oxygen adsorbed onto the oxygen carrier releases from said oxygen carrier. Preferably the second temperature is between approximately 473° K. and approximately 873° K., wherein the second temperature is typically between approximately 623° K. and approximately 823° K.

As described above and shown in FIG. 2, during the heating step 106, the oxygen carrier is heated to a second temperature at a second oxygen partial pressure 106, causing oxygen adsorbed onto the oxygen carrier in the contacting step 104 to be released. The second oxygen partial pressure is any pressure where oxygen adsorbed onto the oxygen carrier releases. Preferably the second oxygen partial pressure is between approximately 0 atm and approximately 0.1 atm, wherein the second pressure is typically between approximately 0 atm and approximately 0.01 atm.

A salient feature of the invention is the performance of the invented oxygen carrier when used in a process such as that shown in FIG. 2. In an embodiment, during the heating step 106 using the invented B-site doped perovskite oxygen carrier, the oxygen carrier has a minimum temperature to begin releasing oxygen, often called a material's desorption onset temperature between approximately 473° K. and approximately 523° K.

Also during the heating step 106, the invention provides maximum desorption temperatures, the temperature where the oxygen carrier releases oxygen at the fastest rate, that are superior to the prior art. In an embodiment, the maximum desorption temperature during the contacting step using the invented B-site doped perovskite oxygen carrier is between approximately 673° K. and approximately 773° K.

Still further, during the heating step, the invention provides improved reduction rates compared to the prior art. In embodiment, the reduction rate during the contacting step using the invented B-site doped perovskite oxygen carrier is between approximately 0.033 wt %/min and approximately 1.5 wt %/min.

### B-Site Doped Perovskite Oxygen Carrier Synthesis Detail

The invented Sr₁₋ₓCaₓFe_{1-y}Ni_{y}O₃ oxygen carriers 10 were synthesized using methods described in E. J. Popczun, D. N. Tafen, S. Natesakhawat, C. M. Marin, T.-D. Nguyen-Phan, Y. Zhou, D. Alfonso, J. W. Lekse, Journal of Materials Chemistry A 2020, 8, 2602-2612 and E. J. Popczun, T. Jia, S. Natesakhawat, C. M. Marin, T. D. Nguyen-Phan, Y. Duan, J. W. Lekse, ChemSusChem 2021, the entirety of which are both incorporated by reference herein. Briefly, stoichiometric amounts of strontium (II) carbonate [SrCO₃, 99.9%, Sigma-Aldrich], calcium (II) carbonate [CaCO₃, 99.5%, Alfa-Aesar], iron (III) oxide [Fe₂O₃, 99.9%, Alfa-Aesar], and nickel (II) oxide [NiO, 99%, Sigma-Aldrich] powders were added to an agate mortar. The powder mixture was manually ground for roughly 15 min to ensure homogeneity. The powder mixture was then pelletized using a 13-mm die assembly in a Carver manual pellet press at a pressure of 4 metric tons. These pellets were loaded into an alumina combustion boat and calcined at 850° C. for 40 hours as pretreatment. Upon cooling, each pellet was ground and subsequently pelletized to remove any inhomogeneities from initial grinding. These pellets were calcined at 1100° C. for 64 hours to yield the final product. Samples were stored in scintillation vials as powders until used.

### B-Site Doped Perovskite Oxygen Carrier Characterization and Performance Detail

For experiments involving the invented B-site doped perovskite oxygen carriers, XRD patterns were collected on a PANalytical X'Pert Pro X-Ray diffractometer with a typical diffraction range of 5-80° 2-theta in a Bragg-Brentano configuration. Cu Kα (λ=1.541 Å) was used as the X-ray source.

For experiments involving the invented B-site doped perovskite oxygen carriers, ex situ synchrotron-based XRD patterns were collected on Beamline 17-BM at Advanced Photon Source (APS), Argonne National Laboratory. The X-ray wavelength was 0.24136 Å. A Perkin-Elmer amorphous silicon area detector at a diffraction distance of 0.7 m was used to collect transmission diffraction images from fine powdered samples loaded into capillary tubes. This image data was integrated in GSAS-II to a 2-theta versus intensity format.

For experiments involving the invented B-site doped perovskite oxygen carriers, scanning electron microscopy (SEM) images were collected using a FEI Quanta 600F SEM equipped with an Oxford Inca X-Act EDX detector. Images and spectra were collected at 20 keV.

For experiments involving the invented B-site doped perovskite oxygen carriers, O₂-TPD experiments were carried out on a Micromeritics 2950HP system equipped with a Pfeiffer Vacuum Thermostar Mass Spectrometer. A quartz sample tube packed with quartz wool acted as the reaction vessel. The tube containing a known quantity of sample (roughly 200 mg) was heated at a ramp rate of 10° C. min⁻¹ to 800° C. and held for one hour under zero-grade air flow at 50 sccm. The system was rapidly cooled to room temperature under air flow, before switching to ultrahigh purity He (50 sccm) for 30 minutes to ensure removal of residual oxygen. The material was then heated to 1050° C. at 10° C. min⁻¹ while the mass spectrometer analyzed the outlet gas. Upon completion, the system was cooled rapidly to room temperature.

For experiments involving the invented B-site doped perovskite oxygen carriers, TGA data was collected on a Mettler-Toledo TGA/DSC 3+ with a standard gas flow of 75 sccm. Approximately 50 mg of sample was placed in a platinum pan to start. Prior to air/N₂ cycling experiments, a priming step was necessary to enable faster kinetic response. This priming step requires heating the sample to 800° C. under zero-grade air flow at a ramp rate of 10° C. min⁻¹ followed by switching to ultrahigh-purity N₂ and holding at 800° C. for 30 minutes prior to cooling. Priming was completed a second time to analyze oxidation thermodynamics. Air/N₂ cycling experiments were performed by heating the sample in air using a variable ramp rate described in the literature to reach the desired cycling temperature. See T. Jia, E. J. Popczun, J. W. Lekse, Y. Duan, Applied Energy 2021, 281, 116040; E. J. Popczun, D. N. Tafen, S. Natesakhawat, C. M. Marin, T.-D. Nguyen-Phan, Y. Zhou, D. Alfonso, J. W. Lekse, Journal of Materials Chemistry A 2020, 8, 2602-2612; E. J. Popczun, T. Jia, S. Natesakhawat, C. M. Marin, T. D. Nguyen-Phan, Y. Duan, J. W. Lekse, ChemSusChem 2021, the entirety of all three hereby incorporated by reference herein. The gas flow was then changed between N₂ and air at set intervals (400° C.—1 hour, 450/500° C.—30 minutes), while weight loss was recorded. Data analysis was performed using the STARe Evaluation Software provided by Mettler Toledo.

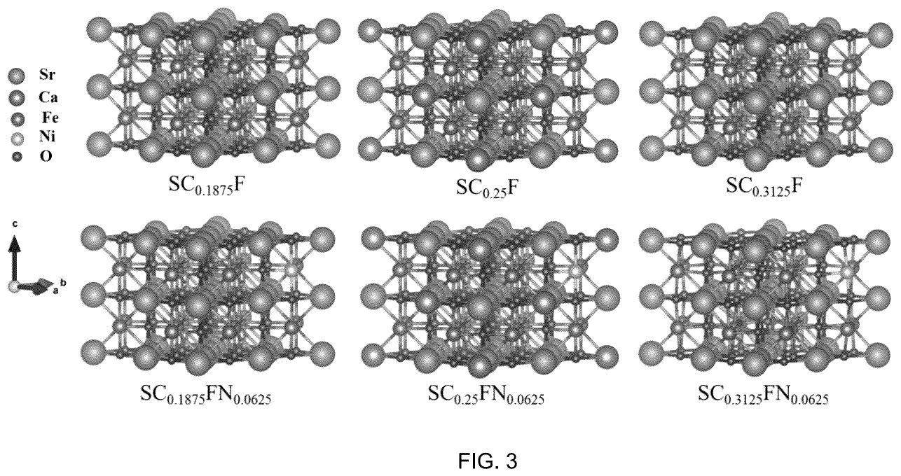

For experiments involving the invented B-site doped perovskite oxygen carriers, density functional theory (DFT) calculations were performed with the Vienna ab initio simulation package (VASP), using the projector-augmented wave (PAW) method described in P. E. Blöchl, Physical Review B 1994, 50, 17953-17979 which is hereby incorporated by reference in its entirety herein. Electron exchange and correlation was treated using the Perdew-Burke-Ernzerhof (PBE) generalized gradient approximation (GGA). All calculations used a plane-wave expansion with an energy cutoff of 450 eV and included spin polarization. The computational models of doping materials Sr₁₋ₓCaₓFe_{1-y}Ni_{y}O₃ were generated using a 2\sqrt{2}×2\sqrt{2}×2 supercell (80 atoms) of the cubic perovskite SrFeO₃. The optimized cubic lattice constant of SrFeO₃ (SFO) is 3.841 Å, which agrees well with the experimental value of 3.857 Å as reported in P. Manimuthu, C. Venkateswaran, Journal of Physics D: Applied Physics 2011, 45, 015303, the entirety of which is incorporated by reference herein. A 3×3×5 Monkhorst-Pack k-point sampling was used for this 2\sqrt{2}×2\sqrt{2}×2 supercell. The 80-atom Sr₁₆Fe₁₆O₄₈ cell allows one to reach the Ca A-site doping value of x=0.1875, 0.25, 0.3125 and Ni B-site doping value of y=0.0625. The doping configurations of Sr₁₋ₓCaₓFe_{1-y}Ni_{y}O₃ (x=0.1875, 0.25, 0.3125, y=0, 0.0625) used in these calculations are shown in FIG. 3. The atomic position relaxation and volume relaxation were performed iteratively to do the structural optimization. Volume and atomic positions were optimized until the total energy was changed within 10⁻⁴ eV per atom and the Hellmann-Feynman force on each atomic fell below 0.01 eV/Å.

Oxygen vacancy (V_{O}) in Sr₁₋ₓCaₓFe_{1-y}Ni_{y}O₃ was modeled by removing a neutral O atom from these 2\sqrt{2}×2\sqrt{2}×2 supercells, producing a nonstoichiometry Sr₁₋ₓCaₓFe_{1-y}Ni_{y}O_{3-δ} material with δ=0.0625. Considering that the change of lattice constants is negligible at such low V_{O} concentration, only the atomic positions are fully relaxed in calculating the total energy of the nonstoichiometry materials. Then, the V_{O} formation energy E_{f} could be obtained from EQUATION 2 shown below.

$${E}_{f} = {E}_{def} - {E}_{perf} + \frac{1}{2} [ E ( {O}_{2} ) + Δ h ] \qquad EQUATION 2$$

In EQUATION 2, E_{def} is the total energy of the nonstoichiometry material with one V_{O}, E_{perf} is the total energy for a perfect lattice, E(O₂) is the total energy of an isolated O₂ molecule, and Δh is the energy correction term, which is from the oxide formation energy disagreement between experiments and DFT calculations (1.36 eV/O₂ for PBE method).

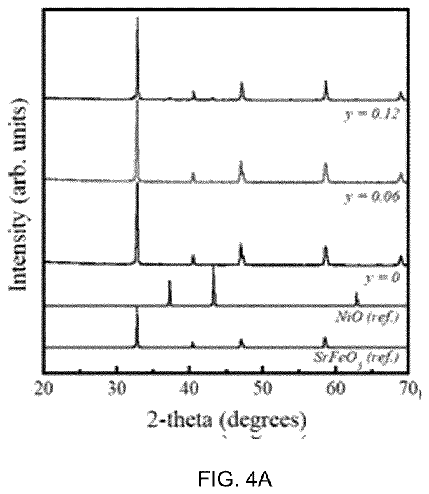

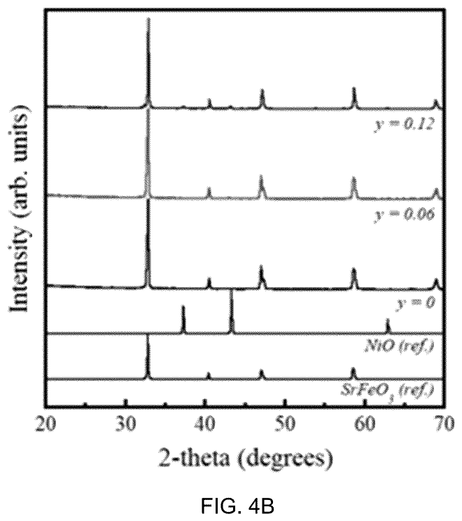

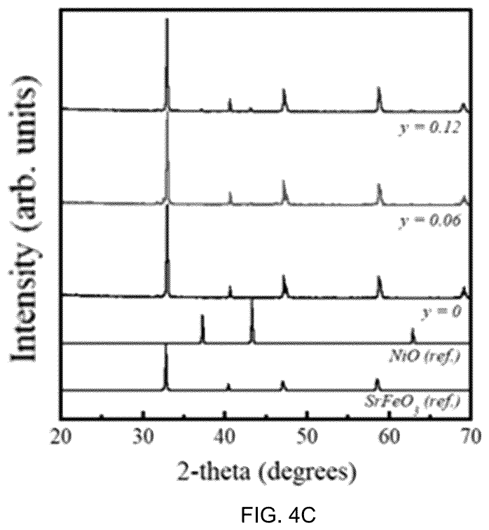

Laboratory-based X-ray diffraction (XRD) was used to determine the major crystal structure and any crystalline impurities of the invented B-site doped perovskite materials. FIGS. 4A-4C contain the XRD patterns for all nine of the investigated materials along with reference patterns for a typical perovskite, SrFeO₃, and free nickel oxide, NiO. The major patterns are consistent with the reference SrFeO₃ perovskite structure but shift due to the contraction of the unit cell due to the substitution of Ca²⁺ (r=114 pm) for Sr²⁺ (r=132 pm) in the structure. Through the attempted substitution of Ni to the Sr₁₋ₓCaₓFeO₃ lattice, NiO impurities are observed as y is increased to 0.12 in all three of the materials (x=0.20, 0.25, 0.30), but they are nonexistent or undetectable at y=0.06. This suggests the maximum Ni B-site substitution in bulk Sr₁₋ₓCaₓFeO₃ falls between y=0.06 and 0.12 and further B-site substitution would cause B-site deficiencies and potential structural changes in the perovskite.

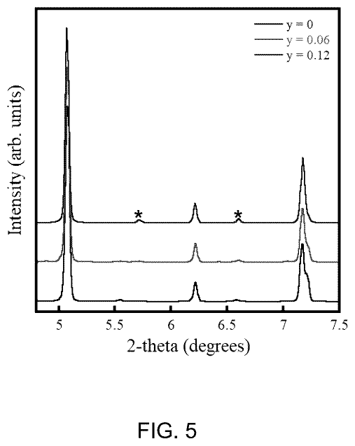

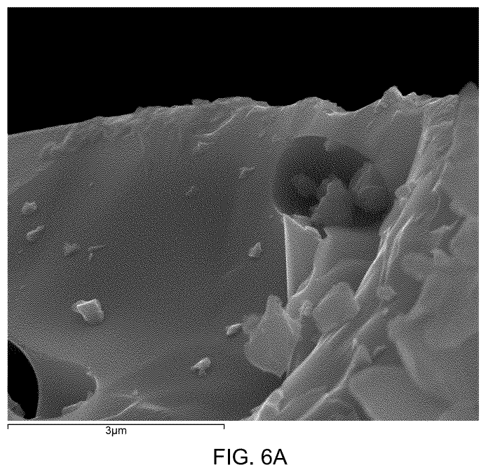

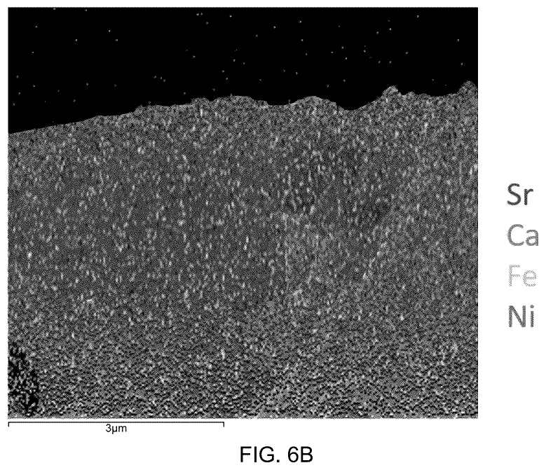

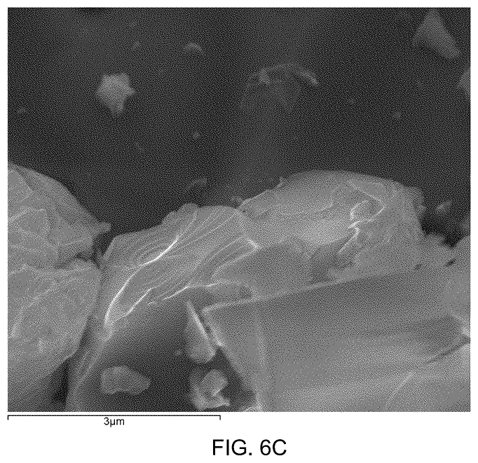

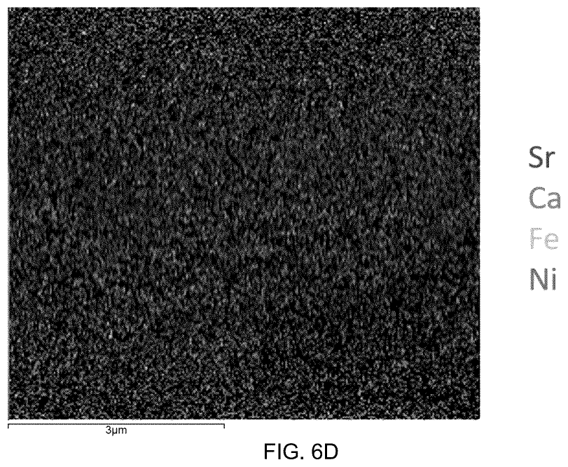

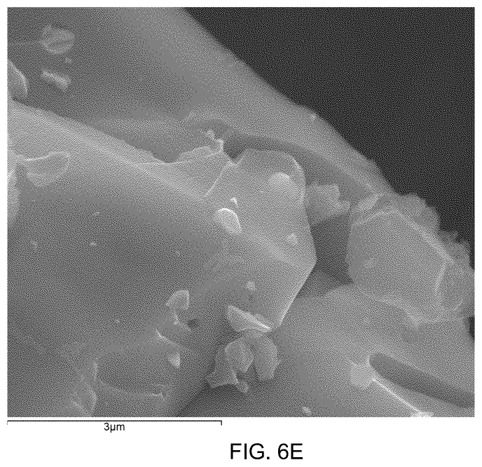

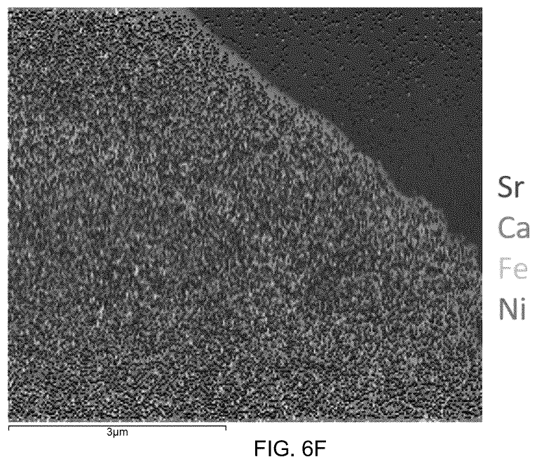

Synchrotron-based X-ray diffraction clearly showed the presence of crystalline NiO in the Sr_{0.75}Ca_{0.25}Fe_{1-y}Ni_{y}O₃ (y=0.12) oxygen carrier 10 as shown in FIG. 5. Scanning electron microscopy with energy dispersive X-ray spectroscopy corroborates this finding for Sr_{0.75}Ca_{0.25}Fe_{1-y}Ni_{y}O₃ samples as well as shown in FIG. 6. In addition to the NiO reflections, the reflection between 7 and 7.5 degrees 2-theta gradually changes shape as Ni content is increased. A secondary reflection appears alongside the major reflection for y=0, whereas this reflection condenses to a shoulder in y=0.06 and disappears completely in the y=0.12 pattern. This minor difference, that was undetectable by laboratory-based X-ray diffraction suggests lower crystallographic symmetry (likely orthorhombic perovskite) among the y=0 and 0.06 materials when compared to the y=0.12 material (cubic perovskite). While the orthorhombic and cubic perovskite structures are highly similar, the symmetry inherent to the cubic structure has been associated with fast redox kinetics in other perovskite materials.

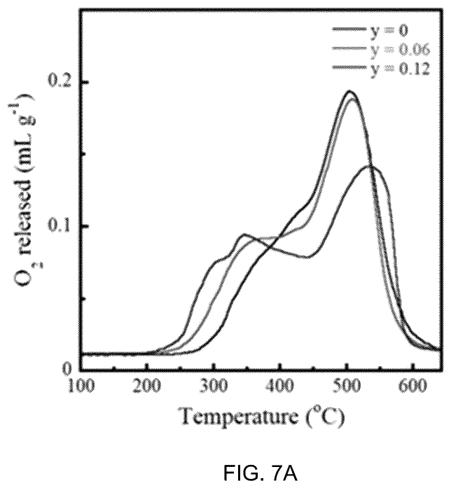

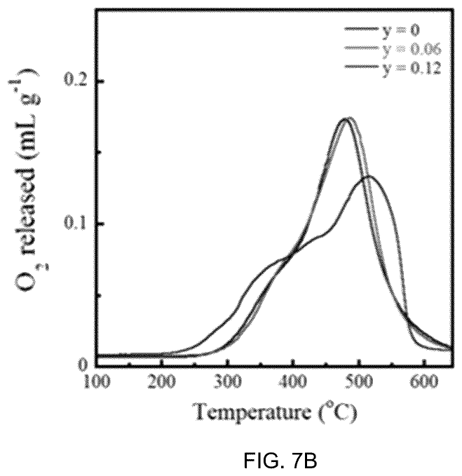

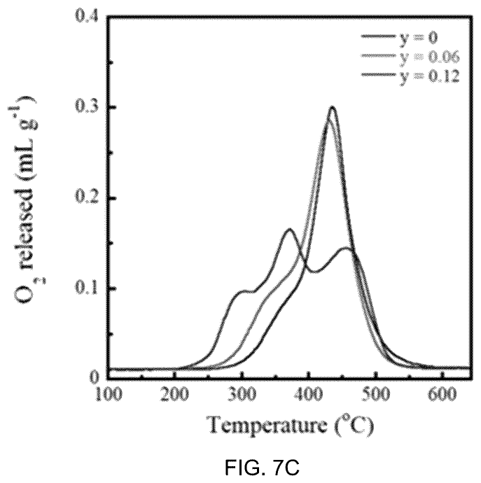

The thermodynamics and kinetics changes of oxygen desorption or adsorption associated with nickel-doping in the invented B-site doped perovskite oxygen carrier 10 were probed using O₂ temperature programmed desorption (TPD) and thermogravimetric analysis (TGA). In FIGS. 7A-7C and summarized in TABLE 1, the O₂-TPD for each material presents two significant results among the series. First, an increase in Ca²⁺ content causes the maximum desorption temperatures to decrease. Second, increasing Ni substitution level does not significantly alter the maximum desorption temperature in y=0.06 materials, but can cause a lower temperature shoulder to form in the desorption profile. Due to these shoulders, the onset desorption temperature decreases as nickel content increases for most of the materials. The lone exception is the x=0.25, y=0.06 material. Interestingly, this material behaves nearly identically to the x=0.25, y=0 material. For the y=0.12 materials, a significant increase in maximum desorption temperature is observed, while the entire profile is broadened, and secondary low temperature peak emerges, pushing the onset desorption temperature further to lower temperatures.

TABLE 1

| | Onset Desorp. | Max Desorp. | |
|---|---|---|---|
| Material | Temp. | Temp. | |
| Sr_{0.8}Ca_{0.2}FeO₃ | 248° C. | 505° | C. |
| Sr_{0.8}Ca_{0.2}Fe_{0.94}Ni_{0.06}O₃ | 210° C. | 507° | C. |
| Sr_{0.8}Ca_{0.2}Fe_{0.88}Ni_{0.12}O₃ | 179° C. | 346/538° | C. |
| Sr_{0.75}Ca_{0.25}FeO₃ | 226° C. | 478° | C. |
| Sr_{0.75}Ca_{0.25}Fe_{0.94}Ni_{0.06}O₃ | 226° C. | 486° | C. |
| Sr_{0.75}Ca_{0.25}Fe_{0.88}Ni_{0.12}O₃ | 197° C. | 516° | C. |
| Sr_{0.7}Ca_{0.3}FeO₃ | 246° C. | 434° | C. |
| Sr_{0.7}Ca_{0.3}Fe_{0.94}Ni_{0.06}O₃ | 223° C. | 430° | C. |
| Sr_{0.7}Ca_{0.3}Fe_{0.88}Ni_{0.12}O₃ | 188° C. | 305/372/456° | C. |

TABLE 1 provides approximate onset and maximum desorption temperatures during O₂ temperature programmed desorption in Sr₁₋ₓCaₓFe_{1-y}Ni_{y}O₃ oxygen carriers. Generally, the onset desorption temperature decreases as Ni content is increased. The maximum desorption temperature decreases with increasing Ca content.

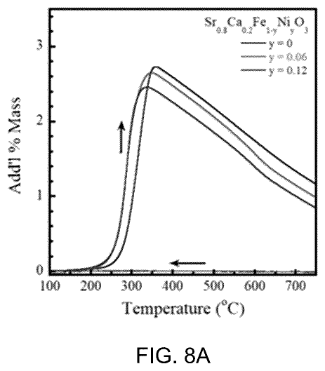

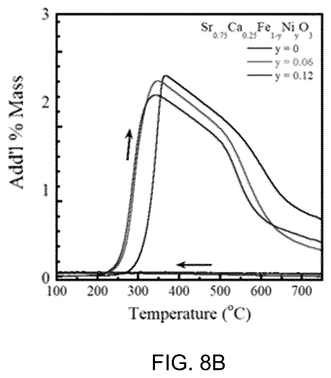

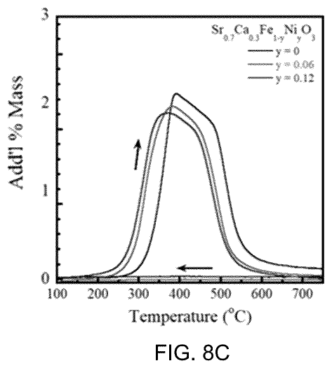

Oxygen adsorption experiments in the TGA reveal similar behavior for the invented oxygen carriers 10 as shown in FIGS. 8A-8C and TABLE 2. Higher onset and maximum oxygen adsorption temperatures as Ca substitution increases were observed. Additionally, nickel B-site substitution decreases both the onset and maximum oxygen adsorption temperature. For all three series, the onset desorption temperature between y=0.06 and y=0.12 materials is relatively consistent. This further suggests the maximum Ni B-site substitution in bulk Sr₁₋ₓCaₓFeO₃ must fall between these two values, as previously noted from XRD results. In addition, the maximum oxygen capacity (OSC), defined as the difference between oxygen content in air (forward direction) and N₂ (baseline), decreases systematically as Ni content increases for all Ca content series tested. The decreased OSC observed between these materials suggest that Ni-doped materials should cycle less O₂ at temperatures above 400° C.

TABLE 2

| Material | Max Adsorp. Temp. |
|---|---|
| Sr_{0.8}Ca_{0.2}FeO₃ | 360° C. |
| Sr_{0.8}Ca_{0.2}Fe_{0.94}Ni_{0.06}O₃ | 348° C. |
| Sr_{0.8}Ca_{0.2}Fe_{0.88}Ni_{0.12}O₃ | 337° C. |
| Sr_{0.75}Ca_{0.25}FeO₃ | 366° C. |
| Sr_{0.75}Ca_{0.25}Fe_{0.94}Ni_{0.06}O₃ | 348° C. |
| Sr_{0.75}Ca_{0.25}Fe_{0.88}Ni_{0.12}O₃ | 342° C. |
| Sr_{0.7}Ca_{0.3}FeO₃ | 392° C. |
| Sr_{0.7}Ca_{0.3}Fe_{0.94}Ni_{0.06}O₃ | 384° C. |
| Sr_{0.7}Ca_{0.3}Fe_{0.88}Ni_{0.12}O₃ | 371° C. |

TABLE 2 provides the approximate maximum adsorption temperatures collected by thermogravimetric analysis of Sr₁₋ₓCaₓFe_{1-y}Ni_{y}O₃ oxygen carriers. Generally, the maximum adsorption temperature decreases as Ni content increases.

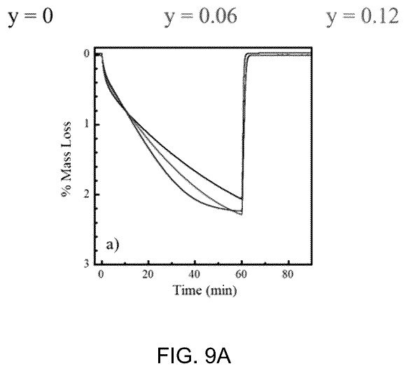

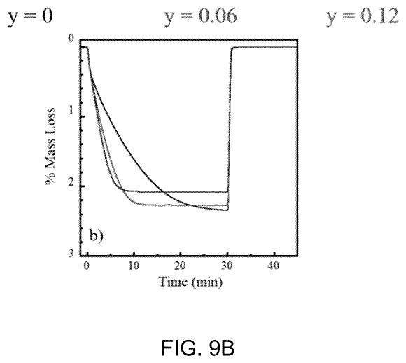

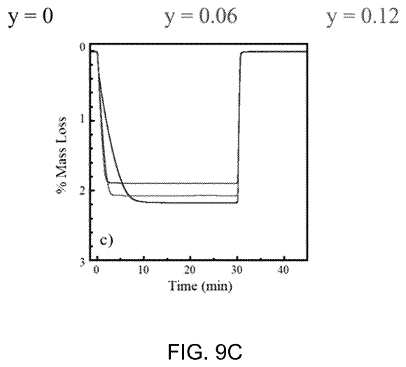

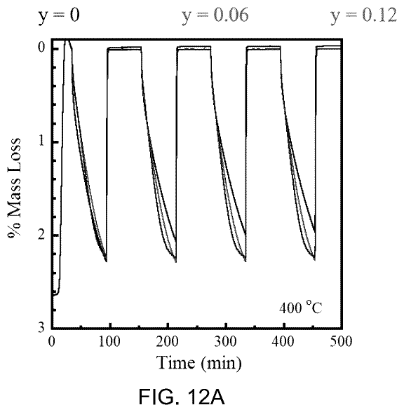

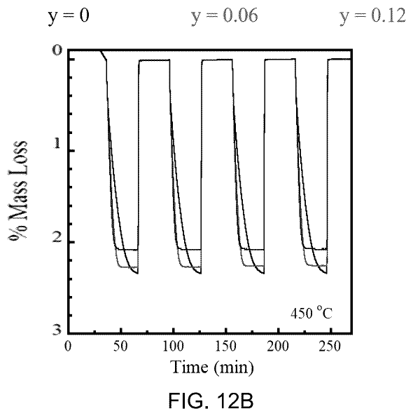

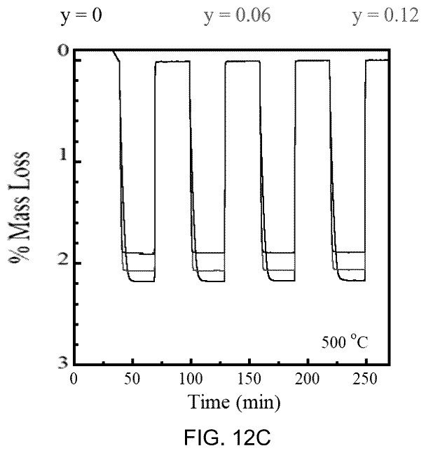

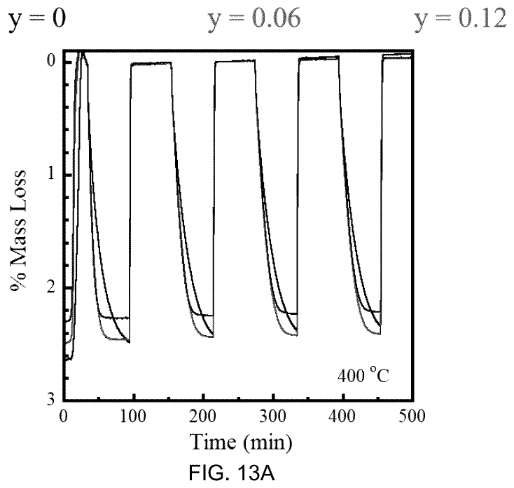

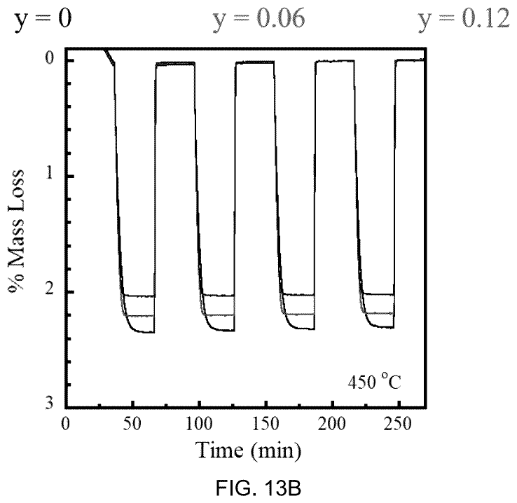

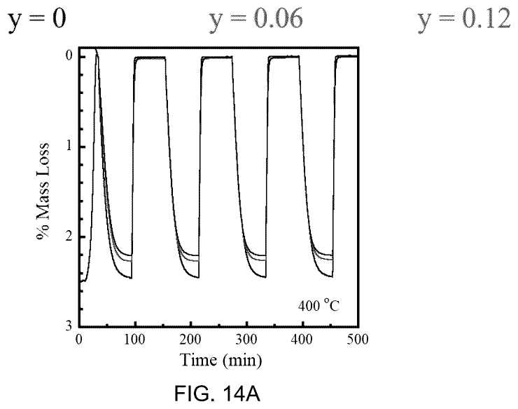

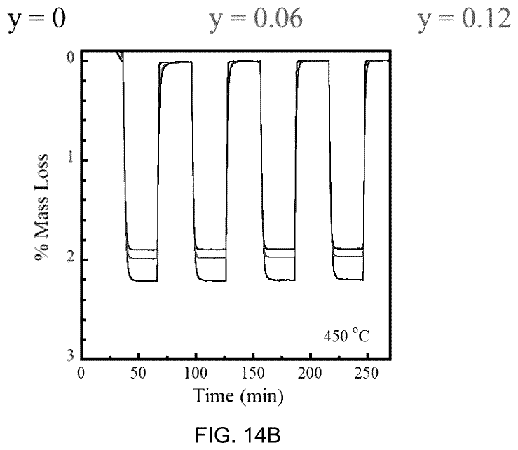

While defining the maximum oxygen storage capacity for these materials using O₂-TPD and TGA adsorption experiments, the invented B-site doped perovskite oxygen carrier 10 was using pressure-swing induced O₂ storage and release. FIGS. 9A-9C, 10A-10C, and 11A-11B contain mass-time plots for each material when they are switched between Air (21% O₂) and N₂ flows at 400, 450, and 500° C. in 30 or 60-min intervals four times. These plots are limited to show only the second redox cycle to emphasize kinetic differences, whereas the full experiments can be found in FIGS. 12A-C, 13A-B, and 14A-B. The focus remained on the reduction/mass loss aspect of these experiments, as the full oxidation process was rapid (<1 min), unless otherwise noted.

FIGS. 9A-9C contain TGA traces for the x=0.20 series at 400, 450, and 500° C. At the low temperature end (400° C., FIG. 9A), iterative improvement is observed as nickel substitution is increased. In fact, the y=0.12 sample takes roughly 30 min to reach 2.00 wt % whereas y=0.06 takes 45 min and y=0 requires 60 min. In addition, the y=0.12 nears its maximum oxygen loss, while the y=0.06 and y=0 materials do not. At 450° C. (FIG. 9B), all three materials reach near-equilibrium before or as the 30-min reduction cycle is completed. At this temperature, the most significant benefit of nickel substitution was observed. Indeed, the time to reach 2.00 wt % for each sample has a similar trend to 400° C., with 5, 8, and 15 min being required for the y=0.12, 0.06, and 0 samples, respectively. However, total oxygen storage capacity is highly limited for the y=0.12 material. At 500° C., the same kinetic benefits are observed from nickel substitution, but desorption for all three materials is more rapid, but with a decrease in possible cyclable oxygen. In fact, the y=0.12 material does not cycle 2.00 wt % at 500° C., but y=0.06 and y=0 do so in 3 and 6 min, respectively. However, as suggested by earlier adsorption experiments, the maximum oxygen storage capacity is lower for this material at 450° C. and 500° C.

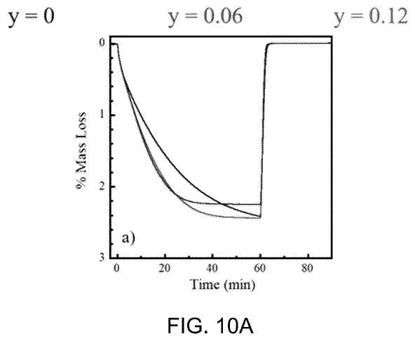

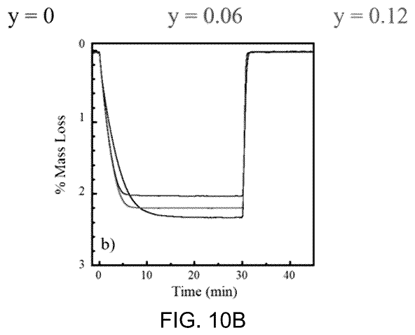

TGA traces for the x=0.25 series at 400° C. and 450° C. are found in FIGS. 10A-10B. Unlike in the x=0.20 series, no significant kinetic benefit was gained from increasing the nickel substitution from y=0.06 to y=0.12. At 400° C. (FIG. 10A), both the nickel-substituted materials lose 2.00 wt % in 20 min compared to 30 min for the nickel-free material. At 450° C. (FIG. 10B, the same metric requires ˜4 min, 5 min, and 7 min for the y=0.06, 0.12, and 0 samples, respectively. While initially faster, the y=0.12 sample has a maximum OSC only slightly higher than 2.00 wt % and the rate of desorption decreases in these samples as they approach this maximum. In an application where rapid O₂ release is preferred at lower than 2.00 wt %, the y=0.12 material may be used, but for maximum O₂ cycling y=0.06 is suggested.

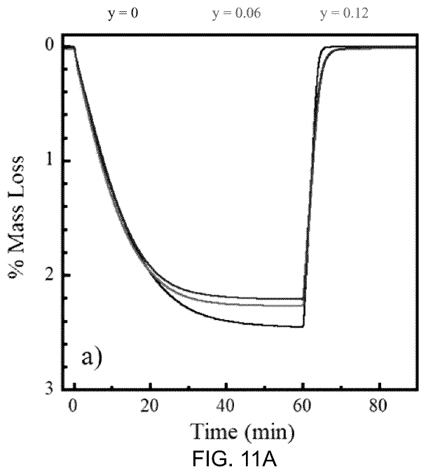

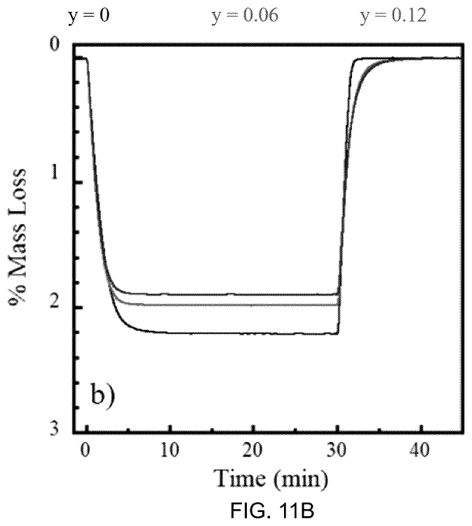

Investigation of the x=0.30 series at 400° C. and 450° C. is displayed in FIGS. 11A-11B. For both temperatures, there is no observable kinetic benefit to nickel substitution versus the nickel-free material. In fact, the nickel-free sample is preferred, as its maximum OSC is significantly higher for both temperatures tested. Furthermore, the oxidation kinetics for the y=0 material are better than the nickel-substituted samples as well, but not as fast as the x=0.20 or x=0.25 materials. It is likely that the nickel does not fully incorporate into the x=0.30 materials, even at y=0.06, as the oxygenated structure is already destabilized from the high Ca content, which can be seen in the wider oxygen adsorption profile for the nickel-free material (FIG. 8C).

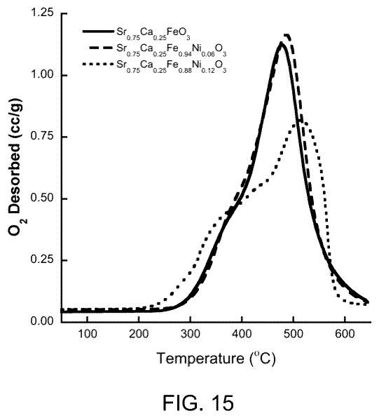

The inclusion of Ni in place of some of the iron in Sr₁₋ₓCaₓFeO₃, leads to distinctly different thermodynamic or kinetic properties for the material. Oxygen temperature programmed desorption illustrates the change in the thermodynamics of oxygen release that are afforded by this change. These results can be seen in FIG. 15 for 0<y<0.125, as an example of ratio dependence. The small amount of nickel does not directly affect the thermodynamic release of oxygen. In addition, thermogravimetric analysis of oxygen uptake (or removal from an air stream) defines the thermodynamics of the material to uptake oxygen at a range of temperatures.

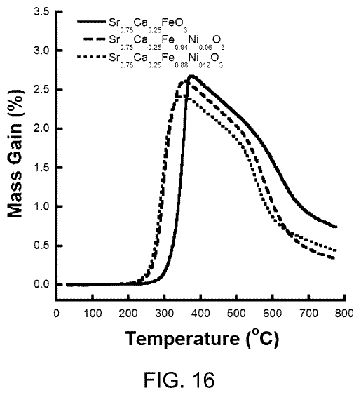

As shown in FIG. 16, the addition of nickel to Sr₁₋ₓCaₓFeO₃ causes oxygen uptake at a significantly lower temperature. This difference of roughly 20° C. in peak storage temperature and roughly 50° C. in oxidation onset temperature are important to the ensuring the materials are oxidized as quickly as possible.

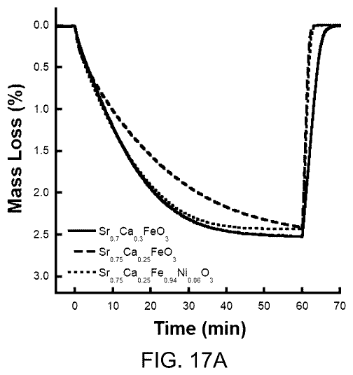

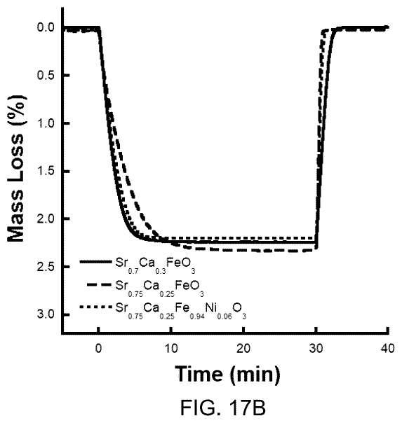

The kinetics aspect of this oxygen carrier can be seen in FIGS. 17A-17B, which are a thermogravimetric analysis traces of the invented oxygen carrier, two containing nickel and one not containing nickel, being cycled at a low temperatures of 400° C. and 450° C. A small addition of the nickel to this material shows an increase in the rate of oxygen release while maintaining the rapid uptake of the sample without nickel. At 450° C., for example, a typical sample of Sr_{0.75}Ca_{0.25}FeO₃ releases roughly 2.1 wt. % O₂ in 10 minutes, whereas the nickel-doped sample (Sr_{0.75}Ca_{0.25}FeO₃) requires only 5 minutes. In an oxygen storage unit that would cycle these materials, the nickel-doped sample would be able to produce the full 2.1 wt. % in a total redox cycle of 6 minutes, whereas the undoped material would require 11 minutes, nearly doubling the amount of pure O₂ that is produced.

In fact, this Sr_{0.75}Ca_{0.25}Fe_{0.94}Ni_{0.06}O₃ material would be preferred to the Sr_{0.7}Ca_{0.3}FeO₃ with similar oxygen release kinetics as well, due to its ability to maintain faster oxygen uptake kinetics. While this process is usually much faster than the reduction, a full redox cycle of the 2.1 wt. % O₂ would require 6 minutes for the Ni-doped material, whereas Sr_{0.7}Ca_{0.3}FeO₃ would require 7-8 minutes. This amounts to a 33% increase in O₂ output for a realistic air separation unit.

### Density Functional Theory on B-Site Doped Perovskite Oxygen Carrier

To determine the reason for improved performance in most of the nickel-substituted perovskite oxygen carriers 10 discussed herein, density functional theory was employed on a selection of Sr₁₋ₓCaₓFe_{1-y}Ni_{y}O₃ (x=0.1875, 0.25, 0.3125; y=0, 0.0625). The y=0.12 materials were excluded from DFT calculations due to substantial NiO exsolution and/or impurities at this high Ni substitution value as confirmed by XRD (FIGS. 4A-4C and FIG. 5).

To begin, the Ca and Ni doping effect on the crystal and electronic structures was analyzed. As shown in TABLES 3-5, the lattice constants decrease with an increase in the amount of Ca and further decrease by Ca and Ni dual-substitution, due to the smaller ionic size of Ca and Ni than Sr and Fe. In addition, the single Ca substitution causes a small deviation of Fe—O bond length from 1.920 Å in SrFeO₃, while dual-substitution with Ni induces a relatively larger deviation of Fe—O bond length in Fe—O—Fe chains and yields longer Ni—O and shorter O—Fe bond lengths in Ni—O—Fe chains. For example (TABLE 5), the largest difference (0.1 Å) between Ni—O and O—Fe bond lengths in Ni—O—Fe chains and a remarkable deviation of Fe—O bond length in Fe—O—Fe chains were reached at the highest Ca A-site (x=0.3125) and Ni B-site (y=0.0625) dual-substitution. Generally, Ni B-site substitution has a larger effect on the bond length than Ca A-site substitution, and Ca/Ni dual-substitution can promote the bond length deviation.

TABLE 3

| | | Distances of | | | |
|---|---|---|---|---|---|
| | | Fe—O (Ni—O), | | | |
| y | a (Å) | O—Fe (Å) | E_{f} (eV) | E_{bond} (eV) | Eᵣₑₗₐₓ (eV) |
| 0^{a} | 3.826 | 1.919, 1.919 | 2.093 | 3.240 | −1.147 |
| | | 1.908, 1.908 | 2.022 | 3.146 | −1.124 |
| 0.0625 | 3.825 | (1.958), 1.869 | 1.407 | 2.598 | −1.191 |
| | | (1.943), 1.871 | 1.736 | 2.679 | −0.943 |
| | | 1.921, 1.917 | 1.996 | 3.157 | −1.161 |
| | | 1.914, 1.907 | 1.859 | 2.989 | −1.130 |
| | | 1.927, 1.913 | 1.918 | 3.071 | −1.153 |

TABLE 3 provides the lattice constants a (Å), the distances of Fe—O (Ni—O) and O—Fe in Fe—O—Fe (Ni—O—Fe) chains to create V_{O}, and the formation energies E_{f} (eV), related electrostatic E_{bond} (eV) and structural relaxation Eᵣₑₗₐₓ (eV) terms for Sr_{0.8125}Ca_{0.1875}Fe_{1-y}Ni_{y}O_{3-δ} (y=0, 0.0625).

TABLE 4

| | | Distances of | | | |
|---|---|---|---|---|---|
| | | Fe—O (Ni—O), | | | |
| y | a (Å) | O—Fe (Å) | E_{f} (eV) | E_{bond} (eV) | Eᵣₑₗₐₓ (eV) |
| 0^{a} | 3.824 | 1.912, 1.912 | 2.020 | 3.182 | −1.162 |
| 0.0625 | 3.818 | (1.957), 1.867 | 1.424 | 2.608 | −1.184 |
| | | (1.943), 1.871 | 1.720 | 2.680 | −0.960 |
| | | 1.914, 1.909 | 1.880 | 3.078 | −1.198 |
| | | 1.906, 1.917 | 1.839 | 3.002 | −1.163 |

TABLE 4 provides the lattice constants a (Å), the distances of Fe—O (Ni—O) and O—Fe in Fe—O—Fe (Ni—O—Fe) chains to create V_{O}, and the formation energies E_{f} (eV), related electrostatic E_{bond} (eV) and structural relaxation Eᵣₑₗₐₓ (eV) terms for Sr_{0.75}Ca_{0.25}Fe_{1-y}Ni_{y}O_{3-δ} (y=0, 0.0625).

TABLE 5

| | | Distances of | | | |
|---|---|---|---|---|---|
| | | Fe—O (Ni—O), | | | |
| y | a (Å) | O—Fe (Å) | E_{f} (eV) | E_{bond} (eV) | Eᵣₑₗₐₓ (eV) |
| 0^{a} | 3.818 | 11.921, 1.921 | 2.114 | 3.302 | −1.188 |
| | | 1.897, 1.897 | 1.880 | 3.085 | −1.205 |
| | | 1.910, 1.910 | 1.879 | 3.126 | −1.247 |
| 0.0625 | 3.817 | (1.980), 1.881 | 1.684 | 2.762 | −1.078 |
| | | (1.958), 1.871 | 1.420 | 2.614 | −1.194 |
| | | (1.943), 1.865 | 1.784 | 2.681 | −0.897 |
| | | 1.929, 1.921 | 1.950 | 3.052 | −1.102 |
| | | 1.924, 1.905 | 1.888 | 2.961 | −1.073 |
| | | 1.941, 1.914 | 1.919 | 3.010 | −1.091 |

TABLE 5 provides The lattice constants a (Å), the distances of Fe—O (Ni—O) and O—Fe in Fe—O—Fe (Ni—O—Fe) chains to create V_{O}, and the formation energies E_{f} (eV), related electrostatic E_{bond} (eV) and structural relaxation Eᵣₑₗₐₓ (eV) terms for Sr_{0.6875}Ca_{0.3125}Fe_{1-y}Ni_{y}O_{3-δ} (y=0, 0.0625).

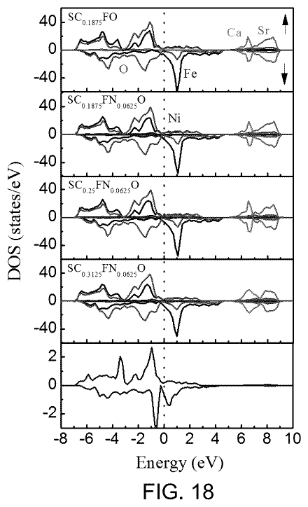

The density of states (DOS) plots for Sr₁₋ₓCaₓFe_{1-y}Ni_{y}O₃ (x=0.1875, 0.25, 0.3125, y=0.0625) are shown in FIG. 18, along with representative DOS for Ni-free Sr_{0.8125}Ca_{0.1875}FeO₃. The single Ca A-site substitution only introduces an empty state located at about 7 eV above the Fermi level while the orbital characteristics near the Fermi level have little change. Electrons are not changed in the material due to the same valence states of Sr²⁺ and Ca²⁺. Conversely, the Ni orbitals are located near the Fermi level with Fe—O hybridization states. However, both the orbital shape and ratio near the Fermi level have no obvious change due to the small Ni substitution value. From the enlarged Ni DOS in the last panel of FIG. 18, the Ni up-spin states are fully occupied and down-spin states are partially occupied, indicating a more possible high-spin Ni³⁺ than low spin Ni⁴⁺. Therefore, it would be expected that the electronic structure has noticeable change at higher Ni substitution values by the valence redistribution from Fe⁴⁺ to Fe⁵⁺/Ni³⁺.

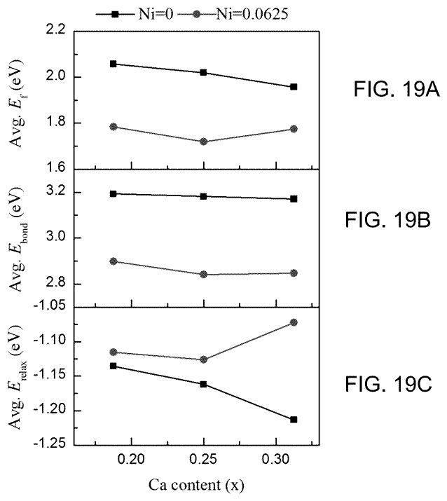

The effect on oxygen vacancy (V_{O}) formation caused by Ca and Ni substitution was also investigated. As mentioned above, the O sites are not equivalent due to the lattice distortion induced by these substitutions. As shown in TABLES 1-5, a series of V_{O} was introduced by removing the O atom from nonequivalent Fe—O—Fe or Ni—O—Fe chains. The vacancy formation energy was averaged, E_{f}, for all Ca/Ni substitution values and portrayed the avg. E_{f} versus Ca content (x) in FIG. 19A. It is shown that the E_{f} decreases slightly as Ca content increases in the Ni-free materials, but there is a more obvious decrease of E_{f} in the materials when Ni is added. Notably, the effect of Ni substitution is most significant at x=0.20 and decreases as Ca content increases further. This corresponds well with experimental findings, where improved activity at x=0.20 and 0.25 but not in the x=0.30 material was observed.

To explore the origin of this enhanced effect on E_{f} due to Ni, E_{f} was divided into two terms: E_{f}=E_{bond}+Eᵣₑₗₐₓ, where the bonding energy (E_{bond}) is the energy required to remove an O atom from the lattice, and the relaxation term (Eᵣₑₗₐₓ) is the energy gain from further relaxing the structure with an oxygen vacancy present. The corresponding avg. E_{bond}/Eᵣₑₗₐₓ versus Ca content (x) are shown in FIGS. 19B and 19C. Similar to the E_{f}, the E_{bond} has a large decrease upon substitution with both Ca and Ni. However, the Eᵣₑₗₐₓ exhibits the opposite trend. Therefore, calculations show the E_{f} decrease upon Ca and Ni co-substitution results from the decreased bonding energy. As mentioned above, the inclusion of Ni weakens the Ni—O or Fe—O bond strength. Notably, as shown in TABLES 1-3, the E_{f} and E_{bond} of V_{O} from the Ni—O—Fe chains are always lower than that from Fe—O—Fe chains in the same Ca/Ni dual-doping material, indicating that the Ni—O—Fe bond strength is weaker than Fe—O—Fe and a probable source for the increased kinetics observed experimentally.

### Mesoporous Perovskite Oxygen Carriers

The invention also provides a method for making mesoporous perovskite oxygen carriers and novel perovskite oxygen carriers created thereby.

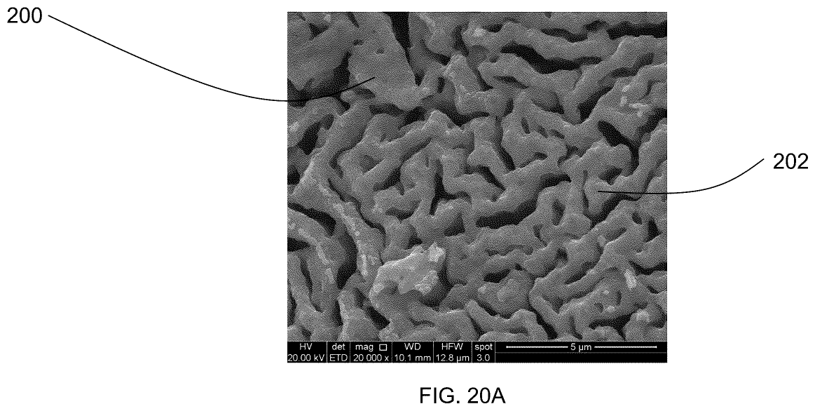

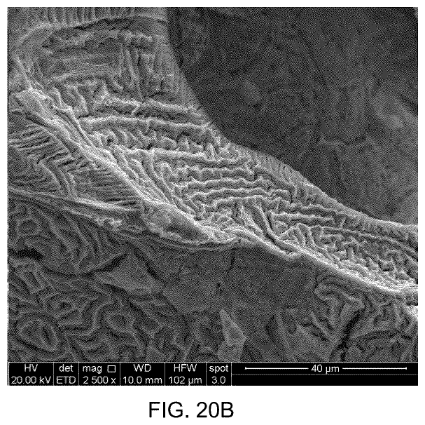

FIG. 20A shows an electron microscopy image of the invented mesoporous perovskite oxygen carrier 200. As shown in FIG. 20A, the invented mesoporous perovskite oxygen carrier 200 comprises nanoparticles 202 that are sintered together, the sintered together nanoparticles 202 comprising a mesoporous network of nanoparticles. The mesoporous network of nanoparticles comprising the mesoporous perovskite oxygen carrier 200 imbues the oxygen carrier 200 with superior and desirable properties over prior art perovskite oxygen carriers such as large surface area. In an embodiment, the nanoparticles in the network each have a diameter between approximately 100 nm to approximately 400 nm.

In an embodiment, the mesoporous perovskite oxygen carrier 200 is a perovskite-type oxygen carrier (ABO_{3-δ}) that has the general formula Sr₁₋ₓCaₓFeO₃, where 0.01<x<0.40. In alternative embodiments the invented mesoporous perovskite oxygen carrier 200 comprises a perovskite-type oxygen carrier with the general formula (Sr₁₋ₓCaₓ)_{0.80-1.20}Fe_{1-y}M_{y}O₃, where 0.05<x<0.40, and where M is a metal selected from the group consisting of scandium, titanium, manganese, nickel, copper, cobalt, zinc, and combinations thereof. In still further alternative embodiments, the mesoporous oxygen carrier 200 comprises Ba₁₋ₓSrₓFeO₃, SrFeO₃, BaFeO₃, La₁₋ₓSrₓFeO₃, non-perovskite oxides (Ruddlesden-Popper, 314-oxides), and combinations thereof.

A salient feature of the invention is the high and superior surface area of the invented mesoporous perovskite oxygen carrier 200 when compared with prior art oxygen carriers. In an embodiment the surface area of the invented mesoporous perovskite oxygen carriers is preferably between approximately 0.4 m²/g of oxygen carrier and approximately 10 m²/g of oxygen carrier, typically between approximately 2.3 m²/g of oxygen carrier and approximately 9 m²/g of oxygen carrier.

### Method of Making Mesoporous Perovskite Oxygen Carriers

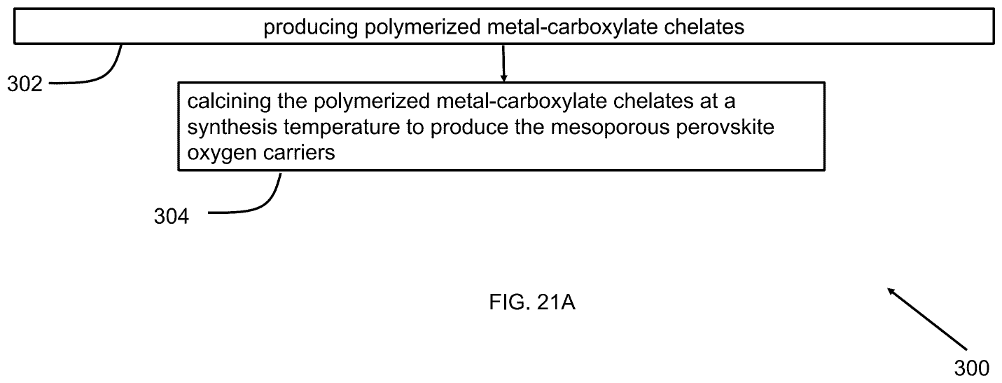

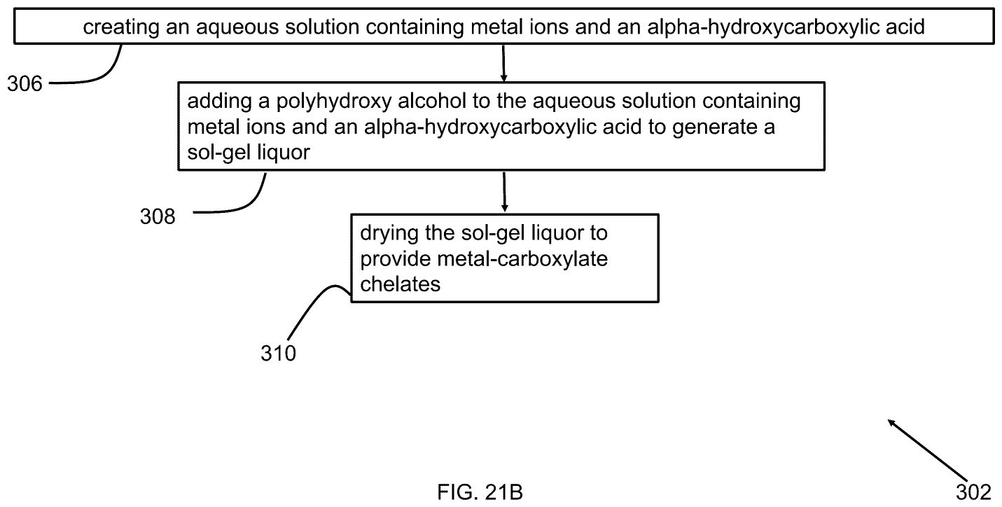

The invention also provides a method to generate mesoporous perovskite oxygen carriers. A schematic of that method 300 shown is shown in FIG. 21A. As shown in FIG. 21A, the method comprises two primary steps. The method begins with producing polymerized metal-carboxylate chelates 302. Subsequently, the method continues by calcining the polymerized metal-carboxylate chelates at a synthesis temperature to produce the mesoporous perovskite oxygen carriers 304. The calcining step 304 comprises heating the polymerized metal-carboxylate chelates to said synthesis temperature and maintaining that temperature for a predetermined period of time.

FIG. 21B is a schematic showing the detail of the producing polymerized metal-carboxylate chelates 302 step of the method to generate mesoporous perovskite oxygen carriers 300 described above and shown in FIG. 21A. The producing polymerized metal-carboxylate chelates 302 step is a sol-gel type synthesis that begins by creating an aqueous solution containing metal ions and an alpha-hydroxycarboxylic acid 306. The producing polymerized metal-carboxylate chelates step 302 continues by adding a polyhydroxy alcohol to the aqueous solution containing metal ions and an alpha-hydroxycarboxylic acid to generate a sol-gel liquor 308. The producing polymerized metal-carboxylate chelates step 302 continues with drying the sol-gel liquor to provide metal-carboxylate chelates 310.

As described above and shown in FIG. 21B, the producing polymerized metal-carboxylate chelates 302 step of the method to generate mesoporous perovskite oxygen carriers 300 comprises creating an aqueous solution containing metal ions and an alpha-hydroxycarboxylic acid 306. In an embodiment, the aqueous solution containing metal ions and an alpha-hydroxylic carboxylic acid is produced by adding salts containing the desired metal ions and alpha-hydroxycarboxylic acid to water. Said desired metal ions comprise ions of the metals to be incorporated in the mesoporous perovskite carriers. For example, in the embodiment where the mesoporous perovskite oxygen carrier has the general formula Sr₁₋ₓCaₓFeO₃, creating an aqueous solution containing metal ions and an alpha-hydroxycarboxylic acid 306 comprises adding Sr, Ca, and Fe salts and an alpha-hydroxycarboxylic acid to water. Any metal salts suitable for co-dissolution in aqueous solution to provide all desired metal ions are suitable.

In an embodiment, the alpha-hydroxycarboxylic acid provided into aqueous solution with the metal ions in step 302 is any alpha-hydroxycarboxylic acid suitable to provide ligands to chelate the metal ions added to solution in step 302. Suitable and exemplary alpha-hydroxycarboxylic acids include citric acid, glycolic acid, lactic acid, mandelic acid, and combinations thereof.

In an embodiment, the polyhydroxy alcohol added in step 308 is any polyhydroxy alcohol suitable to promote polymerization of the metal-carboxylate chelates generated from the metal ions and alpha-hydroxycarboxylic acid combined in step 302. A suitable and exemplary polyhydroxy alcohol is ethylene glycol.

A salient feature of the invented method 300 is the calcining step 304. In the invented method, the polymerized metal-carboxylate chelates are calcined at a synthesis temperature. Said synthesis temperature is below 1000° C. In an embodiment, the synthesis temperature is between approximately 650° C. and approximately 850° C.

### Method of Using Mesoporous Perovskite Oxygen Carrier

$${Sr}_{1 - x} {Ca}_{x} {FeO}_{3 - δ ox ↔} {Sr}_{1 - x} {Ca}_{x} {FeO}_{3 - δ red} + ( \frac{{δ}_{red} - {δ}_{ox}}{2} ) {O}_{2} \qquad EQUATION 3$$

The invented mesoporous perovskite oxygen carrier 200 is suitable for use in temperature and or pressure swing reactions to selectively adsorb and release oxygen. EQUATION 3 above provides the reactions for such a process where the forward reaction of EQUATION 3 shows the reduction of the invented mesoporous perovskite oxygen carrier, i.e., the oxygen carrier releasing oxygen to form a reduced oxygen carrier. The reverse reaction of EQUATION 3 shows the oxidation of the reduced mesoporous perovskite oxygen carrier, i.e., the reduced oxygen carrier adsorbing oxygen to form the invented mesoporous perovskite oxygen carrier 200. The invented mesoporous perovskite oxygen carrier 200 is suitable for use in the method 100 shown in FIG. 2 and described above. When said invented mesoporous perovskite oxygen carrier is used in the method 100 shown in FIG. 2, the invented mesoporous perovskite oxygen carrier 200 comprises the oxygen carrier in the method and the reduced form thereof is the reduced oxygen carrier.

A salient feature of the invention is the performance of the invented mesoporous perovskite oxygen carrier when used in a process such as that shown in FIG. 2. In an embodiment, during the contacting step 104, the reduced oxygen carrier adsorbs between approximately 2.00 wt % and approximately 3.00 wt % of oxygen, often called a material's oxygen storage capacity.

Also during the contacting step 104, when the invented mesoporous perovskite oxygen carrier is used, the invention provides maximum adsorption temperatures, the temperature where the reduced oxygen carrier adsorbs oxygen at the fastest rate, that are superior to the prior art. In an embodiment, the maximum adsorption temperature during the contacting step is between approximately 473° K. and approximately 673° K.

Still further, during the contacting step, when the invented mesoporous perovskite oxygen carrier is used, the invention provides improved oxidation rates compared to the prior art. In embodiment, the oxidation rate during the contacting step is between approximately 0.08 wt %/min and approximately 2.24 wt %/min.

A salient feature of the invention is the performance of the invented oxygen carrier when used in a process such as that shown in FIG. 2. In an embodiment, when the invented mesoporous perovskite oxygen carrier is used in the method 100, during the heating step 106, the oxygen carrier has a minimum temperature to begin releasing oxygen, often called a material's desorption onset temperature between approximately 313° K. and approximately 573° K.

Also during the heating step 106, when the invented mesoporous perovskite oxygen carrier is used in the method 100, the invention provides maximum desorption temperatures, the temperature where the oxygen carrier releases oxygen at the fastest rate, that are superior to the prior art. In an embodiment, the maximum desorption temperature during the contacting step is between approximately 473° K. and approximately 773° K.

Still further, during the heating step, when the invented mesoporous perovskite oxygen carrier is used in method 100, the invention provides improved reduction rates compared to the prior art. In an embodiment, the reduction rate during the contacting step is between approximately 0.03 wt %/min and approximately 1.55 wt %/min.

### Mesoporous Perovskite Oxygen Carrier Characterization and Performance Detail

As described above and shown in FIG. 21A, the invention uses a two-step process to generate the invented mesoporous perovskite oxygen carriers that starts with the production of a porous metal-citrate (citrate as one example of a chelating ligand) complex followed by high-temperature calcination to synthesize the perovskite structure. Because the metal-citrate complex can be easily isolated prior to calcination, the material was suitable for synthesis at various temperatures (700-1000° C.) within a single batch. For this reason, the invented process is ideal to isolate synthesis temperature, Tₛ, as an investigable variable on the structure and oxygen storage activity of Sr_{0.8}Ca_{0.2}FeO₃, Sr_{0.75}Ca_{0.25}FeO₃, and Sr_{0.7}Ca_{0.3}FeO₃ to represent the Sr₁₋ₓCaₓFeO₃ material. For comparison, bulk forms of each composition were also synthesized using a traditional solid-state method. Pretreatment in N₂ immediately preceding oxygen uptake/desorption was also studied. Due to the quantity of materials tested, experiments are referred to using a shorthand notation. For instance, SCF30-1000-P700 represents the Sr_{0.7}Ca_{0.3}FeO₃ material synthesized at 1000° C. using the invented method and pretreatment temperature, Tₚ, of 700° C. Materials labeled SSR instead of the synthesis temperature represent the traditional bulk carbonate/oxide synthesized materials.

To synthesize test samples of the mesoporous Sr₁₋ₓCaₓFeO₃ materials, stoichiometric amounts of strontium nitrate [Sr(NO₃)₂, Fisher-Scientific, Cert. ACS Grade], calcium nitrate tetrahydrate [Ca(NO₃)₂·4H₂O, Sigma-Aldrich, 99%] and iron (III) nitrate nonahydrate [Fe(NO₃)₃·9H₂O, Sigma-Aldrich, 98%] were added to a large beaker. In addition, citric acid [C₃H₅O(COOH)₃, Alfa-Aesar, anhydrous 99.5%] was added to the vessel at a 2.5:1 molar ratio of citric acid to total metal ions along with roughly 10 mL DI water. This mixture was heated to roughly 60° C. and stirred to promote dissolution. At this point, ethylene glycol [(CH₂OH₂)₂, 99%] was added to the warmed solution at a 3.75:1 molar ratio of ethylene glycol to total metal ions. Following this addition, the solution was heated to 120° C. to dehydrate the material. During this heating step, visible NOₓ gas was released from the reaction vessel. The sample was heated further to drive off most of the water, leaving a yellow-orange rigid, porous solid. This beaker was placed directly into an oven to dwell at 120° C. overnight for drying. The resulting powder was removed from the vessel and ground into a rough powder. This powder was then placed in an alumina combustion boat within a quartz tube furnace. The powder was heated in air by ramping with 5° C. min⁻¹ to a desired synthesis temperature (i.e., 700, 750, 800, 850, 900, 950, 1000° C.) and holding for 8 hours. Finally, the resulting black samples were cooled and stored in scintillation vials prior to characterization.

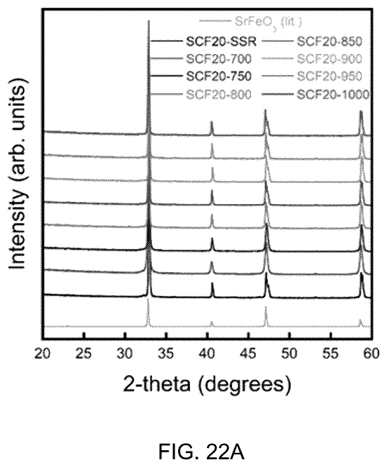

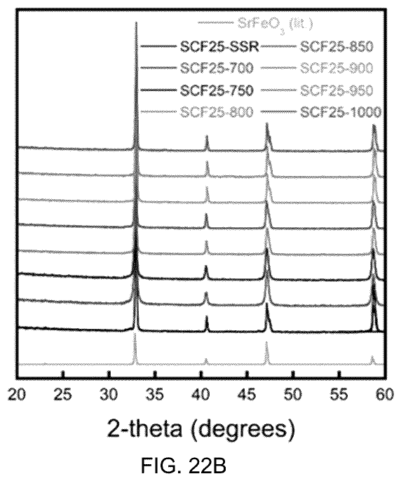

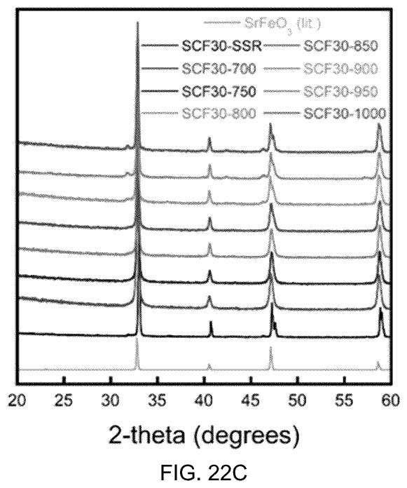

Following synthesis, the perovskite crystal structure was confirmed for all the materials using pXRD, shown in FIGS. 22A-22C. In accordance with previous studies, Ca²⁺ substitution shrinks the SrFeO₃ unit cell leading to a whole-pattern shift towards higher 2-theta. Aside from the expected brownmillerite Sr₂Fe₂O₅ impurities in the Sr_{0.7}Ca_{0.3}FeO₃ material, no other compounds are observed in detectable quantities, including amorphous carbon, usually represented by a broad reflection centered at ca. 27° 2-theta. Interestingly, the brownmillerite impurity only appears when the synthesis temperature is at or above 900° C. Additionally, a cubic-to-orthorhombic perovskite structural transition is observed at 47° 2-theta at approximately 800-900° C. for all three compositions. This, along with minor reflection broadening in the lower temperature patterns, suggests an increase in surface area (decreasing particulate size) and disorder with decreasing temperature.

The bulk materials were synthesized using the traditional solid-state method developed previously for these materials. Briefly, strontium carbonate [SrCO₃, Aldrich, 99.9%], calcium carbonate [CaCO₃, Alfa Aesar, 99.5%], and iron (III) oxide [Fe₂O₃, Alfa Aesar, 99.9%] were combined using manual pulverization and pressed into compact pellets which were thermally treated at 850° C. for 40 hours, followed by a second calcination at 1100° C. for 64 hours.

Powder X-ray diffraction (pXRD) was collected using a PANalytical X'Pert Pro XRD using Cu Kα source (λ=1.541 Å) in a Bragg-Brentano configuration. Scans were collected from 5-80° 2-theta.

For studies involving the invented Sr₁₋ₓCaₓFeO₃ mesoporous perovskite oxygen carriers and Sr₁₋ₓCaₓFeO₃ bulk materials, in-situ pXRD analyses were carried out using a PANalytical PW 3040 X-Pert Pro XRD system equipped with a 60 kv PW 3373/00 Cu LFF high power ceramic tube with a Cu anode and a PW 3011/20 detector. High temperature in-situ pXRD experiments were conducted with an Anton-Parr HTK 1200N equipped with a customized gas inlet System for reactive gas injection and gas switching. In situ reduction was conducted in UHP Argon (50 ml/min) to 1000° C. at a ramp rate of 10° C./min with a 20-minute hold at 700° C. to capture the phase composition at that temperature. Scan parameters were optimized so a single scan (10-110 2θ) would occur over an 18-minute period. A scan was collected at 1000° C. before ramping down to 700° C. where another scan was collected prior to the TPO experiment. The in situ oxidation was carried out in Air (50 ml/min) from 700-1000° C. at a rate of 10° C./min and a scan captured after the sample reached 1000° C. Phase identification was done using PANalytical X-Pert Pro Plus Diffraction analysis software coupled with PDF4-2022 database.

For studies involving the invented Sr₁₋ₓCaₓFeO₃ mesoporous perovskite oxygen carriers and Sr₁₋ₓCaₓFeO₃ bulk materials, scanning electron microscopy was collected using a FEI Quanta 600F SEM with a 20 kV beam and a working distance of 10 mm.

For studies involving the invented Sr₁₋ₓCaₓFeO₃ mesoporous perovskite oxygen carriers and Sr₁₋ₓCaₓFeO₃ bulk materials, Brunauer-Emmett-Teller (BET) surface area and total pore volume were determined by volumetric N₂ adsorption isotherm at −196° C. in a Quantachrome Autosorb 1-C surface area analyzer. Prior to measurements, approximately 2 g of sample was degassed to remove surface moisture under vacuum at 110° C. for 1 hour. Multi-point BET analysis was conducted to determine surface area from the amount of N₂ adsorbed at the relative pressure between 0.1 and 0.3. Total pore volume was calculated from the amount of N₂ adsorbed at P/P₀=0.99.

For studies involving the invented Sr₁₋ₓCaₓFeO₃ mesoporous perovskite oxygen carriers and Sr₁₋ₓCaₓFeO₃ bulk materials, O₂-TPD experiments were carried out in a Micromeritics 2950HP analyzer equipped with a Pfeiffer Vacuum Thermostar MS. All the gas flow rates and ramp rate used were 50 sccm and 10° C. min⁻¹, respectively. In these experiments, the pretreatment temperature was chosen at 650° C., which is below the lowest synthesis temperature to avoid structural changes during pretreatment. Initially, approximately 250 mg of sample was loaded in a U-shaped quartz cell packed with quartz wool and then pretreated in flowing air at 650° C. for 1 hour. Following cooling to room temperature in air, the sample was then heated to 1050° C. in ultra-high purity Ar while evolution of O₂ (m/z=32) and CO₂ (m/z=44) in the outlet stream from the quartz sample cell was monitored by the MS.

For studies involving the invented Sr₁₋ₓCaₓFeO₃ mesoporous perovskite oxygen carriers and Sr₁₋ₓCaₓFeO₃ bulk materials, TGA was performed on a Mettler Toledo TGA/DSC 3+ with a standard gas flow of 75 sccm. Approximately 30-40 mg of sample was placed in a platinum pan to start. A pretreatment was performed to generate rapid kinetics during cycling experiments. Pretreatment requires heating the sample under air flow at a ramp rate of 10° C. min⁻¹ to the investigated temperature, not to exceed the synthesis temperature. The sample is then cooled to room temperature under N₂ flow. This pretreatment step was completed twice to yield valuable information regarding the reoxidation thermodynamics. Following pretreatment, O₂ pressure cycling experiments were performed by heating the sample pan at a rate of 20° C. min⁻¹ under air flow to 250° C. Up to 350° C., the ramp rate was reduced to 10° C. min⁻¹ to avoid an unnecessary overage. The gas flow was then cycled between ultra-high purity N₂ (6 minutes) and zero-grade air (4 minutes), while heat flow and weight loss were recorded. This 10-min cycle was repeated five times for each studied temperature: 350, 375, 400, 450, and 500° C. Data analysis was performed using the STARe Evaluation Software provided by Mettler Toledo.

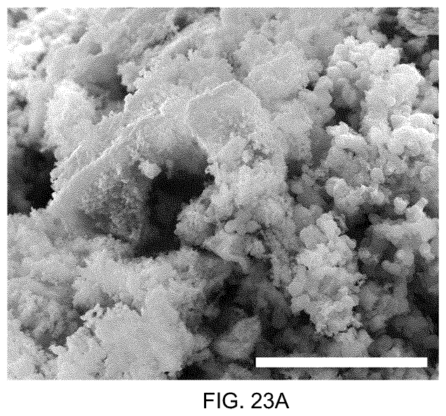

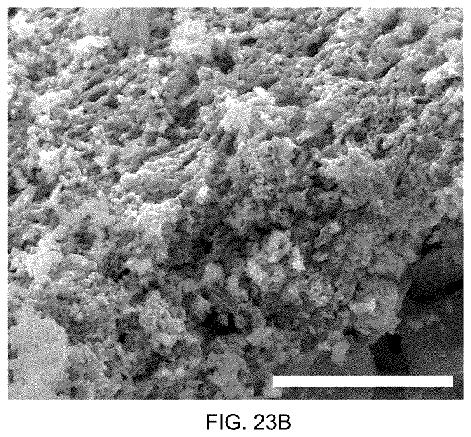

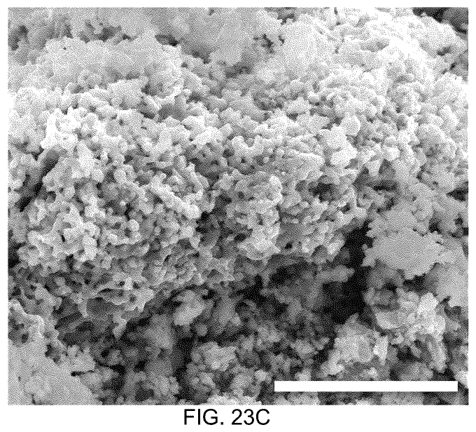

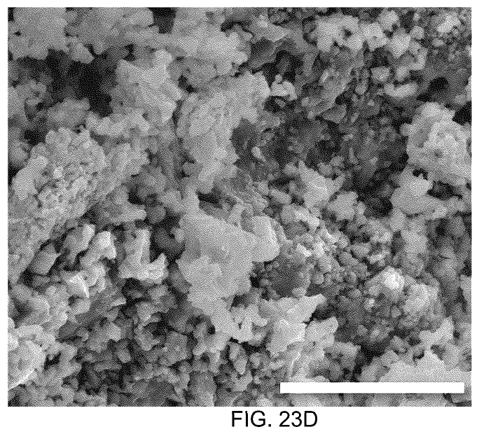

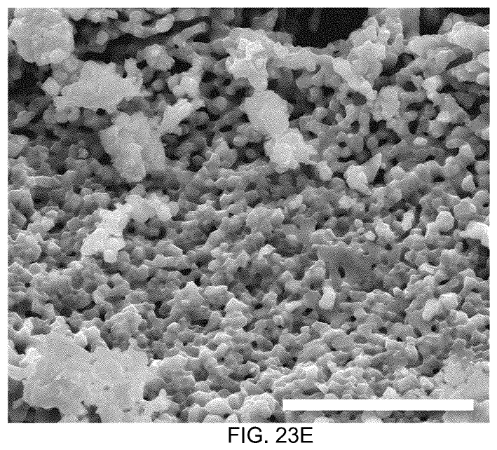

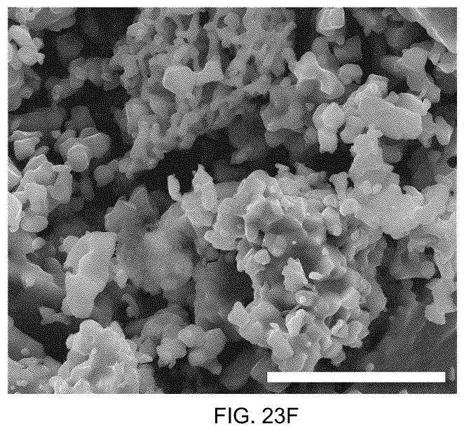

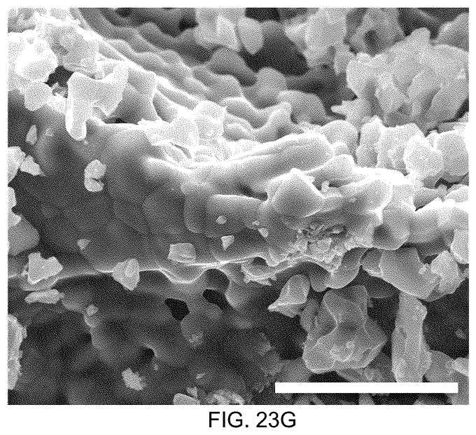

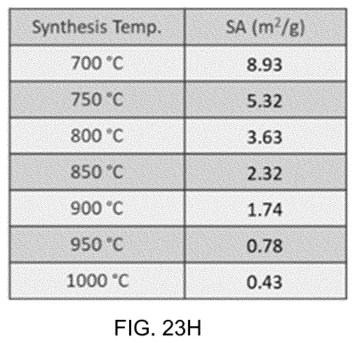

For studies involving the invented Sr₁₋ₓCaₓFeO₃ mesoporous perovskite oxygen carriers and Sr₁₋ₓCaₓFeO₃ bulk materials, to confirm surface area changes with synthesis temperature in these materials, N₂ adsorption isotherm at −196° C. was conducted to determine Brunauer-Emmett-Teller (BET) surface area and total pore volume. FIG. 23H shows the BET surface area steadily decreases in Sr_{0.7}Ca_{0.3}FeO₃ as Tₛ increases from 700° C. (8.93 m²/g) to 1000° C. (0.43 m²/g). For comparison, synthesized bulk Sr_{0.7}Ca_{0.3}FeO₃ has a surface area of 0.54 m²/g. To further illustrate the textural difference between these materials, the total pore volume was investigated for the 800° C. and 900° C. materials. The total pore volume is nearly four times higher at 800° C. (0.0268 cm³/g) than at 900° C. (0.0074 cm³/g).

For studies involving the invented Sr₁₋ₓCaₓFeO₃ mesoporous perovskite oxygen carriers and Sr₁₋ₓCaₓFeO₃ bulk materials, pore volume and textural differences for these materials were visualized using SEM. Using Sr_{0.75}Ca_{0.25}FeO₃ as a second representative perovskite oxygen carrier, the increase in particle size as synthesis temperature rises can be seen in FIGS. 23A-23G, which corroborates reflection broadening in the pXRD results. The morphology of the materials also changes with Tₛ as individual particles sinter together at higher temperatures, creating mesoporous networks that explain the decrease in BET surface area.

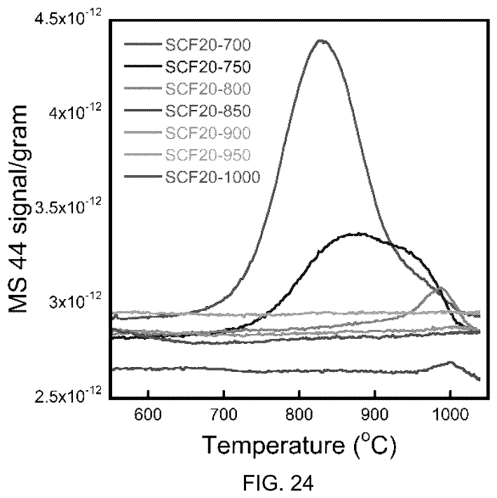

For studies involving the invented Sr₁₋ₓCaₓFeO₃ mesoporous perovskite oxygen carriers and Sr₁₋ₓCaₓFeO₃ bulk materials, CO₂-TPD was utilized to determine the quantity of carbon in each sample, shown in FIG. 24 for representative Sr_{0.8}Ca_{0.2}FeO₃ materials. To perform these experiments, each material was heated to 1050° C. in an ultra-high purity Ar atmosphere with a ramp rate of 10° C. min⁻¹. As expected, the materials with the lowest Tₛ contain the highest observed CO₂ desorption. Despite this finding, no SrCO₃, CaCO₃, or amorphous carbon was observed in the pXRD pattern for any of these samples, meaning surface-bound carbonate and other carbonaceous species were the major contributors to this desorption. The temperature of maximum desorption occurs at approximately 800° C. for the samples synthesized at 700° C. and 750° C., whereas a much less intense second desorption feature is observed near 1000° C. for the materials synthesized at 800° C. and 850° C. only. No observable CO₂ is desorbed from any of the three highest Tₛ samples.

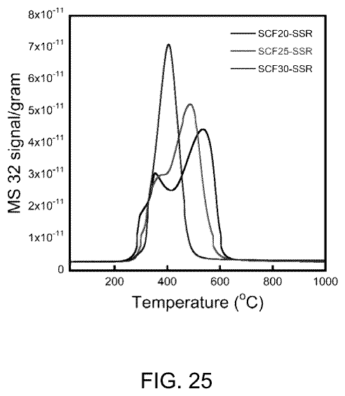

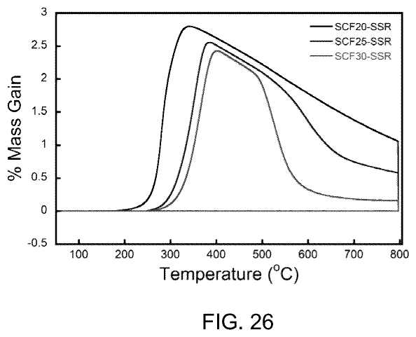

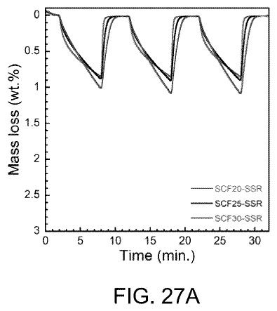

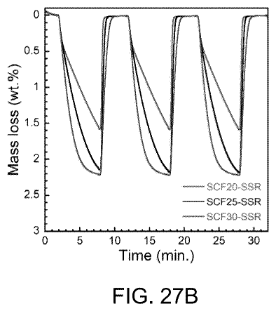

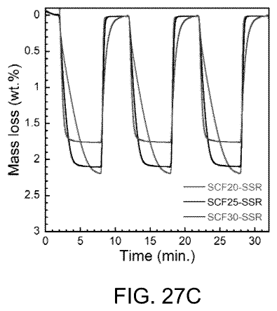

Elemental composition of the perovskite materials within the Sr₁₋ₓCaₓFeO₃ plays a significant role in the oxygen storage capacity of these materials. Briefly, Ca²⁺ for Sr²⁺ substitution leads to lower desorption temperatures, higher adsorption temperatures, and lower overall oxygen storage capacity (OSC), due to the increased structural instability caused by this substitution. Validation of this can be found in FIGS. 25, 26, and 27A-27C, showing O2-TPD traces (FIG. 25), TGA adsorption traces (FIG. 26), and isothermal air/N₂ cycling (FIGS. 27A-27C) at operating temperatures, Tₒ, of 400, 450, and 500° C. with Tₚ=800° C. for the three bulk materials included in these examples. All three sets of data align well with previous studies, with the Sr_{0.7}Ca_{0.3}FeO₃ offering the highest OSC at 400° C. and Sr_{0.8}Ca_{0.2}FeO₃ at 500° C. through 10-minute cycles. At 450° C., the profile of the trace is important to take into consideration, as the Sr_{0.7}Ca_{0.3}FeO₃ releases the most oxygen and is also the quickest. However, the Sr_{0.75}Ca_{0.25}FeO₃ trace shows an incomplete reduction, making both compositions viable at 450° C. For all temperatures, initial oxygen release rates in Sr_{0.7}Ca_{0.3}FeO₃ are much faster than the other two materials.

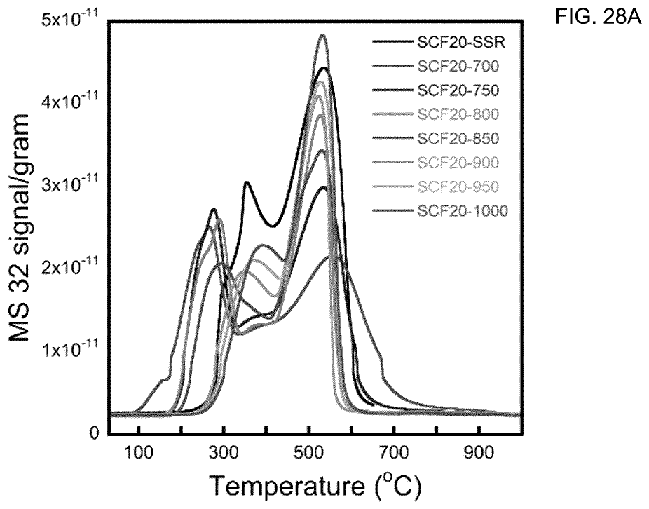

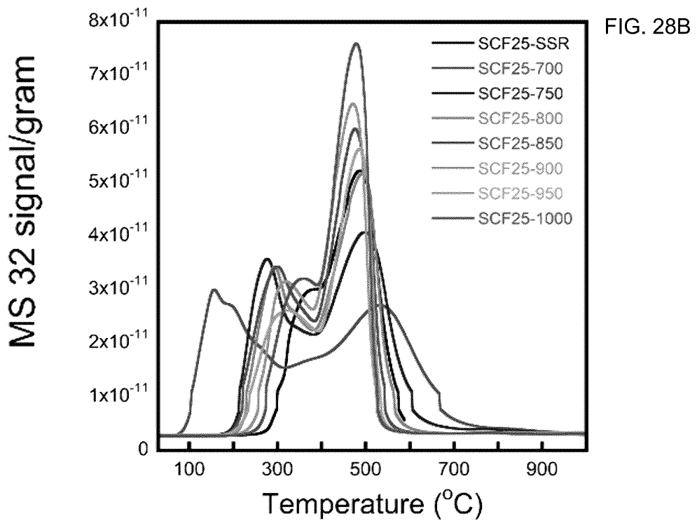

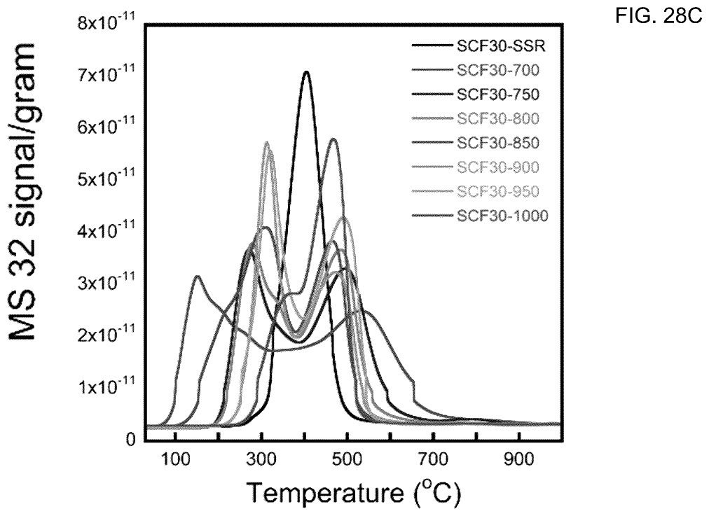

Oxygen temperature-programmed desorption was utilized to offer an insight into the role synthesis temperature plays on the thermodynamics of oxygen release for all three compositions. While calcium content plays a large role in the onset temperature, maximum desorption temperature, and total oxygen desorption in the bulk materials, synthesis temperature can greatly affect these properties as well. As shown in FIGS. 28A-28C, a secondary lower temperature desorption feature develops as Tₛ decreases, greatly lowering the onset desorption temperature for each composition. For example, the approximate onset desorption temperature is lowered to 62, 55, and 40° C. for x=0.20, 0.25, 0.30, respectively. Conversely, the onset desorption temperature for each of the bulk materials is over 200° C. This stark difference is due to the increase in surface-bound oxygen species as the surface area increases.

The position of the major desorption feature in the O₂-TPD also changes. Unlike the emerging surface oxygen peak, the bulk desorption feature shifts towards higher temperatures and decreases in oxygen released (peak area) as the surface area is decreased. The shift to higher temperatures is most pronounced in the Sr_{0.7}Ca_{0.3}FeO₃ series and weakest in the Sr_{0.8}Ca_{0.2}FeO₃ series, but both shifts are subdued in comparison to changes in the surface oxygen feature. It is difficult to establish a trend for the area under the individual peaks due to broadening and overlap. However, a decrease was observed in the maximum mass spectrometer (MS) signal when Tₛ is lowered, as expected from the increase in surface oxygen. Overall, the largest total oxygen desorption over the entire temperature range occurs in the highest surface area materials. Materials with the smallest surface areas tend to have the lowest total oxygen desorption, but some variance does exist amongst these materials.

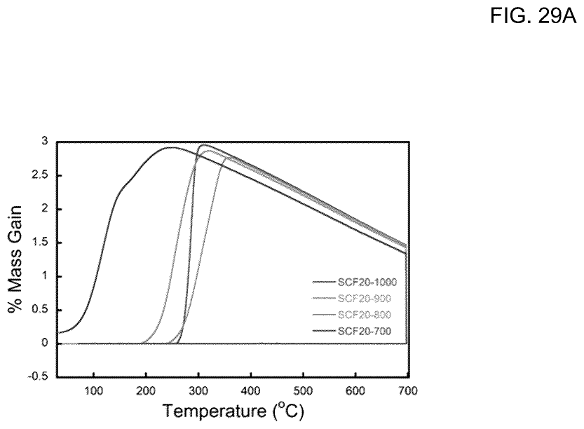

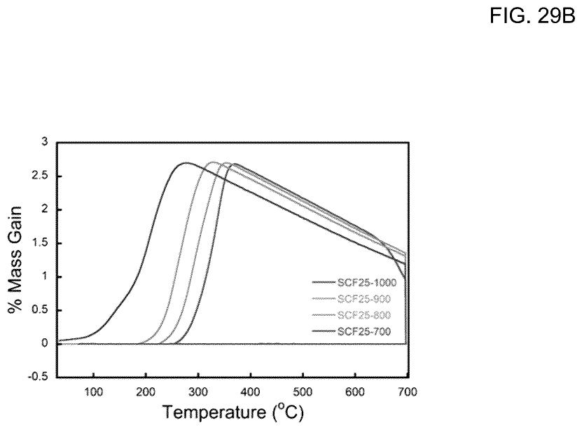

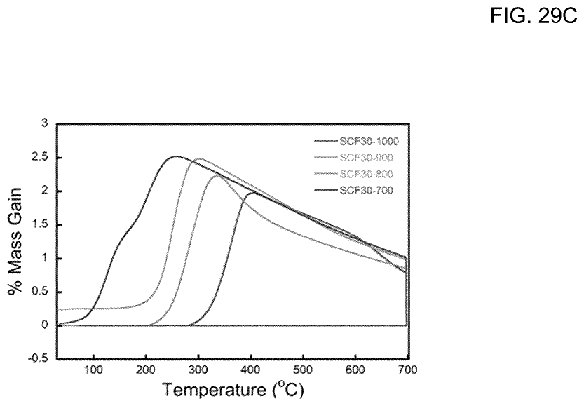

Similar trends are also observed for oxygen adsorption. To examine the role of synthesis temperature on the oxygen adsorption, each material was first pretreated at 700° C. in N₂ and then heated from 30-700° C. at a steady ramp rate of 10° C. min⁻¹. These oxygen adsorption plots can be found in FIGS. 29A-29C. Generally, higher surface area materials can uptake oxygen at lower temperatures, with both the onset temperature and temperature of maximum oxygen content fitting this trend. In fact, in all three materials, the samples with Tₛ=700° C. begin with oxygen uptake below 100° C., whereas higher synthesis temperatures lead to onset temperatures above 200° C. The only exception is Sr_{0.8}Ca_{0.2}FeO₃ with Tₛ=1000° C., which has a much steeper uptake curve leading to maximum uptake temperatures midway through its series, with a trace that nearly aligns with the traditional bulk material (FIG. 26). One other notable takeaway in these oxidation traces is how well each material holds oxygen past their maximum uptake. This value determines the maximum oxygen storage capacity at each temperature. The lower surface area materials made using the invented method 300 maintain oxygen content better than the higher surface area materials; this is easiest to observe in the Sr_{0.75}Ca_{0.25}FeO₃ series.

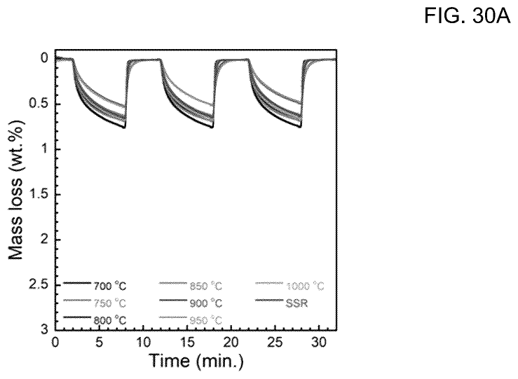

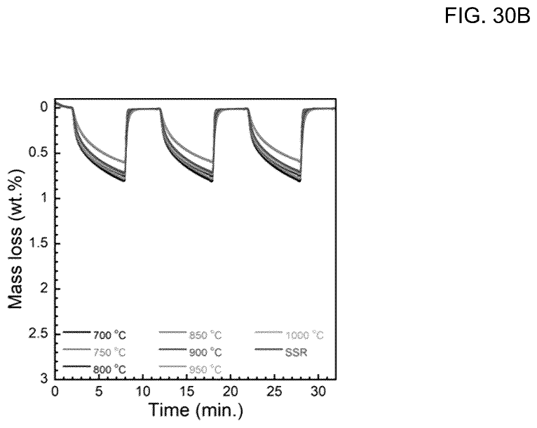

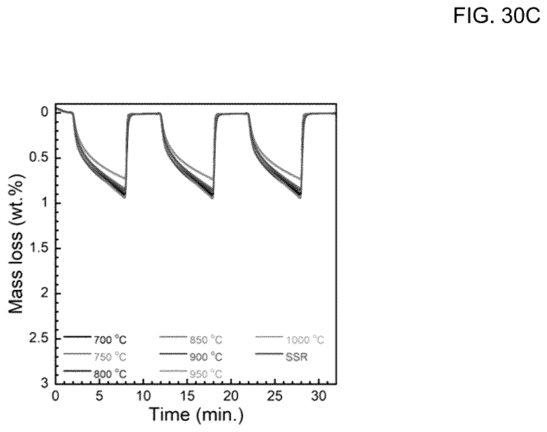

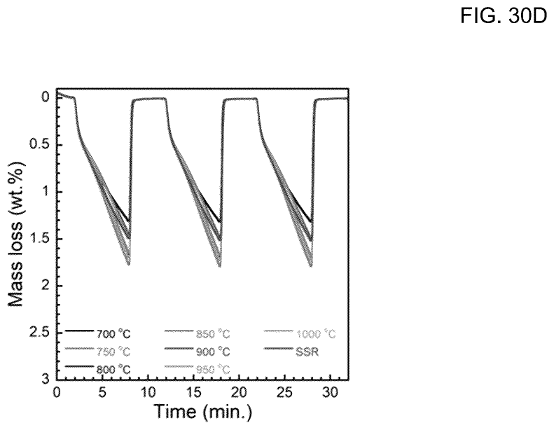

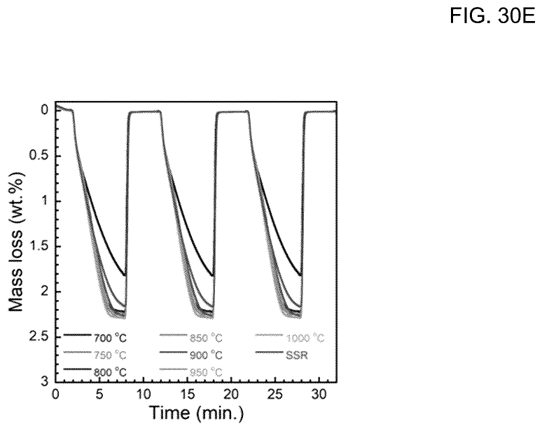

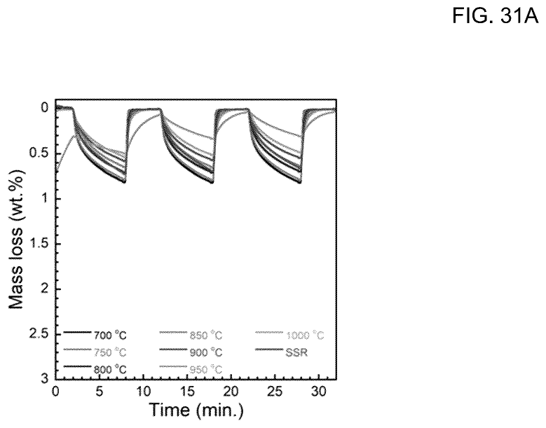

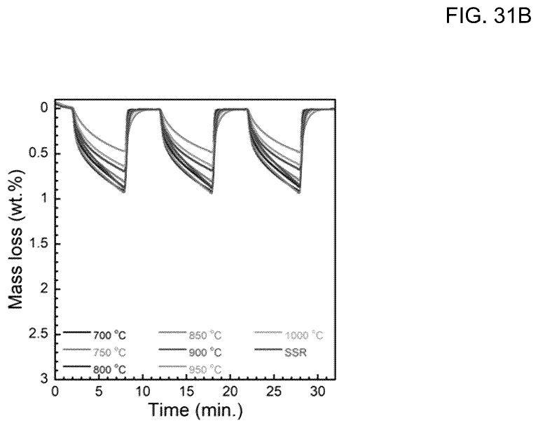

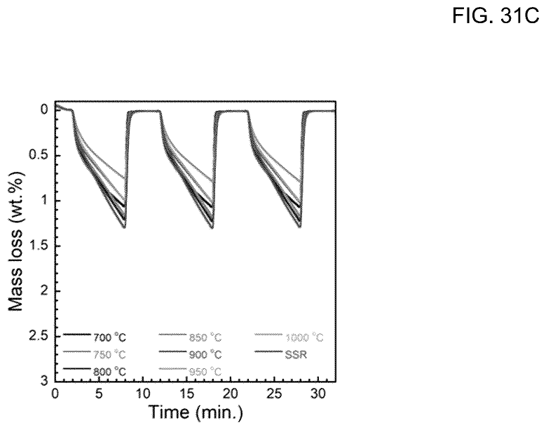

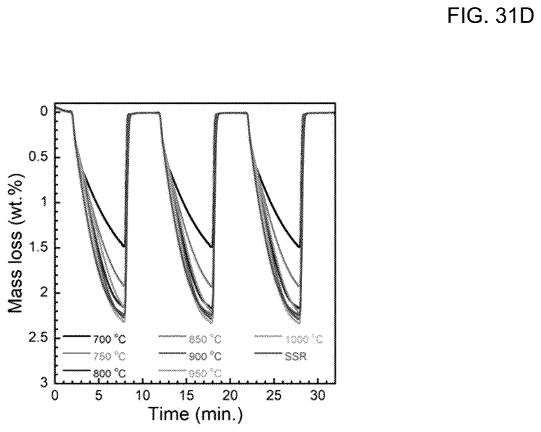

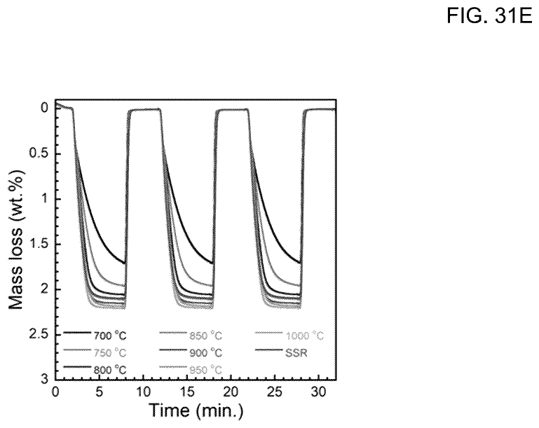

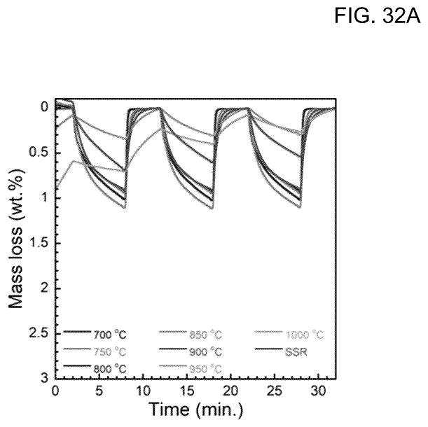

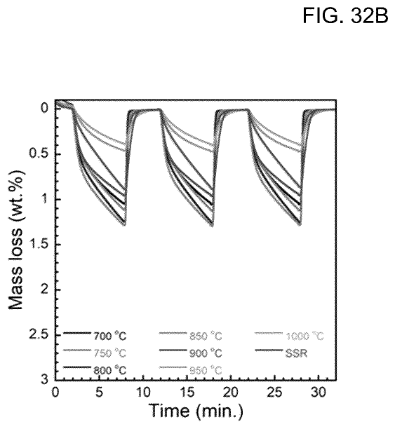

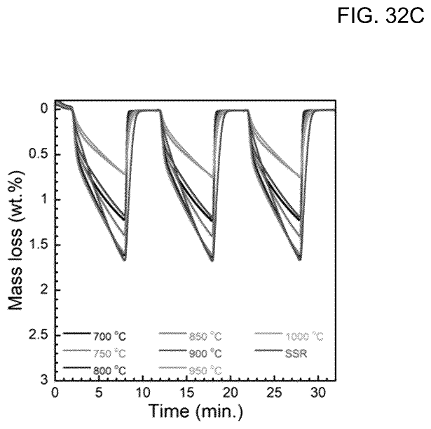

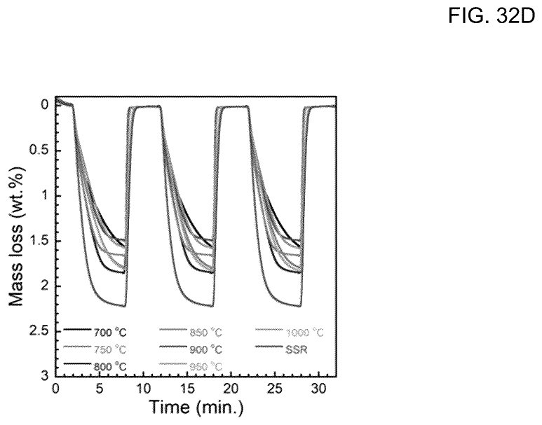

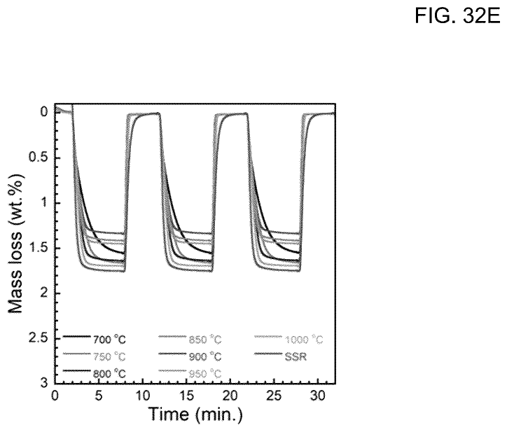

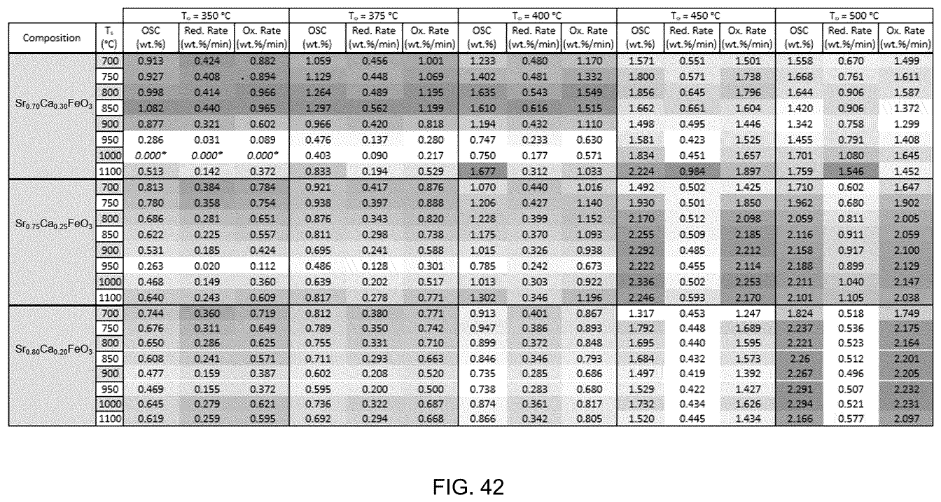

While the prior experiments are helpful in determining the maximum oxygen storage capacity for these materials, the reduction and oxidation kinetics of these materials are important for air separation applications. To study this, short air/N₂ cycling was performed at operating temperatures of 350, 375, 400, 450, and 500° C. allowing 6 minutes for reduction and 4 minutes for oxidation. Each of these experiments was preceded with a standard pretreatment in N₂ at 700° C. Each experiment can be broken down into three distinct factors averaged over three full cycles; oxygen storage capacity for the full cycle, as well as the initial reduction and oxidation rates averaged across the first minute. A collection of this data can be found in the table shown in FIG. 42. FIG. 42 provides average kinetic data determined through thermogravimetry at 350, 375, 400, 450, and 500° C. The OSC is collected after 10-min cycles of 6 min in air and 4 min in N₂. Oxidation and reduction rates were determined using the difference in mass after 1 min following gas switching. All materials were pretreated at 700° C. prior to testing. Values with asterisks were too low or inconsistent for accurate measurement. The table in FIG. 42 provides data collected in the thermogravimetry experiments found in FIGS. 30A-30E, 31A-31E, and 32A-32E.

Analysis began with the lowest operating temperature experiments (i.e., 350, 375, and 400° C.). Upon investigation of the data shown in FIG. 42, attention began with Sr_{0.7}Ca_{0.3}FeO₃ as the other materials are much less active at these temperatures. As shown in the data shown in FIG. 42, oxygen storage capacity peaks at Tₛ=850° C. for all three operating temperatures (1.08 wt. % at 350° C., 1.30 wt. % at 375° C., and 1.61 wt. % at 400° C.). At higher Tₛ, the oxygen storage capacity rapidly lowers. This activity was confirmed in four different batches of materials and the decrease in activity coincides with an emerging presence of Sr₂Fe₂O₅ in the pXRD pattern (FIGS. 22A-22C). The SSR material, which was synthesized at 1100° C., is included in these tables for comparison. For the Sr_{0.70}Ca_{0.3}FeO₃ series, the SSR material has the highest storage capacity at Tₒ=400° C. (1.67 wt. %) but is among the bottom three materials at 350 and 375° C. Additionally, the initial oxidation rate (%/min) couples well with the oxygen storage capacity and is typically approximately 90% of the OSC for the citrate-synthesized materials. This confirms that the reduction rate is the limiting factor in the activity of these materials. In this instance, the reduction rate aligns with the oxygen storage capacity observed in the maximum initial reduction rates for SCF30-850 (0.44 wt. %/min at 350° C., 0.56 wt. %/min at 375° C., and 0.62 wt. %/min at 400° C.).

Unlike the lowest three temperatures, Sr_{0.7}Ca_{0.3}FeO₃ and Sr_{0.75}Ca_{0.25}FeO₃ are both viable at 450° C. While SCF25-1000 has the highest oxygen storage capacity (2.34 wt. %), there are seven total materials with capacities greater than 2.00 wt. %, including SCF30-SSR and the Sr_{0.75}Ca_{0.25}FeO₃ with the six highest synthesis temperatures. As with the lower operating temperatures, the initial oxidation rate is within 90% of the oxygen storage capacity for the Sr_{0.75}Ca_{0.25}FeO₃ series. This is not the case with the bulk Sr_{0.7}Ca_{0.3}FeO₃ material, as only 80% of the oxygen is recovered after 1 minute. Inversely, this Sr_{0.7}Ca_{0.3}FeO₃ material displays the fastest initial reduction rates, releasing nearly 1 wt. % O2 in the first minute, 66% higher than the maximum rate achieved using Sr_{0.75}Ca_{0.25}FeO₃. Aside from SCF25-SSR (0.6 wt. %/min), the initial reduction rate for the Sr_{0.75}Ca_{0.25}FeO₃ series stays near 0.5 wt. %/min. Combining these factors, the highest synthesis temperatures are most viable at this temperature, but calcium content plays the largest role.

Similar effects were observed when studying materials at 500° C. The oxygen storage capacity reaches a maximum of 2.29 wt. % in SCF20-950 and SCF20-1000. Aside from SCF20-700 (1.82 wt. %) and SCF20-SSR (2.17 wt. %), the storage capacity of the full Sr_{0.8}Ca_{0.2}FeO₃ series is above 2.2 wt. % along with SCF25-1000. Oxidation at this temperature is more rapid than that at lower temperatures for all materials. Reduction favors the highest calcium content materials, with SCF30-SSR having a rate of 1.55 wt. %/min and SCF25-SSR at 1.11 wt. %/min, whereas rates for the Sr_{0.8}Ca_{0.2}FeO₃ series are roughly 0.5 wt. %/min. Changes in synthesis temperature only play a small role in oxygen storage at 500° C., confirming calcium content is a more influential variable.

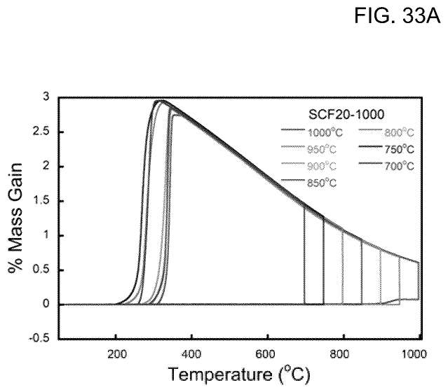

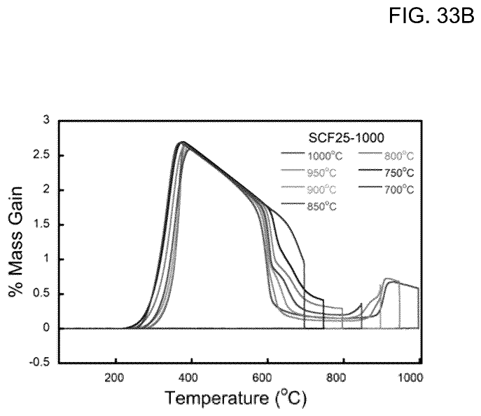

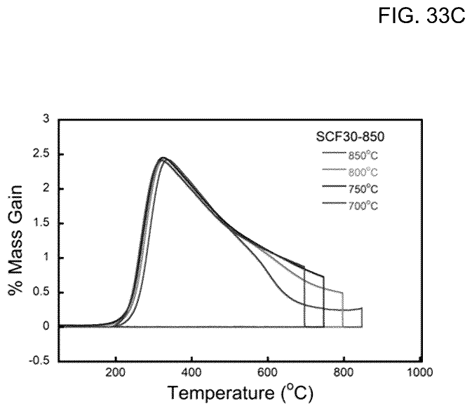

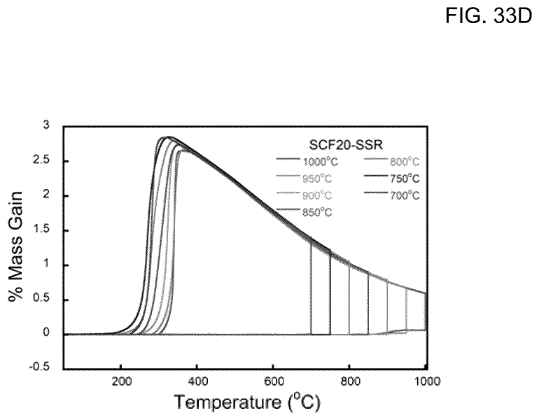

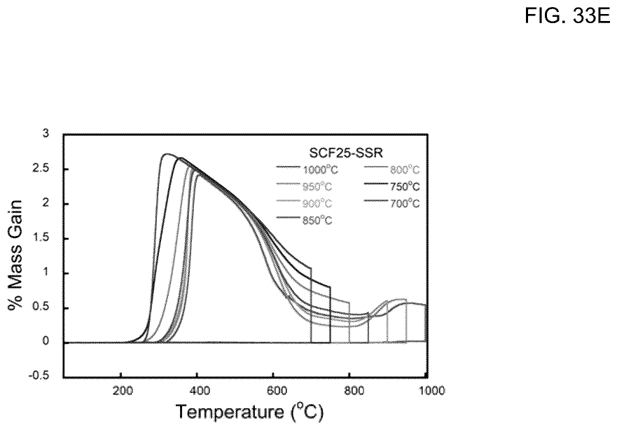

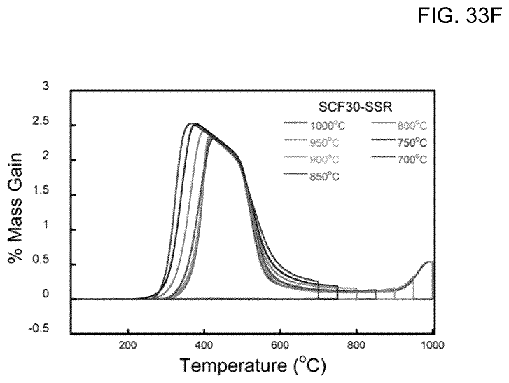

Experiments were also performed to determine the optimal pretreatment conditions for Sr₁₋ₓCaₓFeO₃ oxygen carriers, investigating a Tₚ range from 700-1000° C. To start, the oxidation profile of the best performing citrate-based materials of each composition when pretreated at 700° C. can be found in FIGS. 33A-33F. The materials shown include SCF30-850, SCF25-1000, SCF20-1000, as well as the bulk materials. Three prevailing trends persist in all six materials presented. As with the effects that synthesis temperature has on the oxidation profile, lower pretreatment temperatures generally lead to 1) lower onset temperatures, 2) higher quantities of oxygen adsorption, and 3) an increased oxygen retention at temperatures past the initial maximum uptake temperature. Experiments with Tₚ=700° C. often lead to slightly higher onset temperatures than Tₚ=750° C., but fastest oxidation kinetics are expected for these materials due to the rapid rise in oxygen content once that onset temperature is reached. All other pretreatment temperatures have similar initial slopes following the onset temperature, leading to higher temperatures of maximum oxidation and lower maximum oxygen storage capacities. At the temperatures studying oxygen retention, the role of pretreatment diverges based on the composition of the material. In Sr_{0.8}Ca_{0.2}FeO₃, no observable difference in the oxygen retention for differing pretreatment temperatures can be found. As such, no significant difference in the reduction and oxidation kinetics are expected in higher temperature cycling experiments (450 and 500° C.). Conversely, oxygen retention drastically changes in the other two compositions. The highest pretreatment temperatures cause a large drop in the oxygen content from 500-600° C. in Sr_{0.7}Ca_{0.3}FeO₃ and 550-650° C. in Sr_{0.75}Ca_{0.25}FeO₃. While this drop shows that lower pretreatment temperatures lead to better oxygen retention, the higher oxygen lability in the higher pretreated materials suggest their oxygen desorption kinetics will be much preferred.

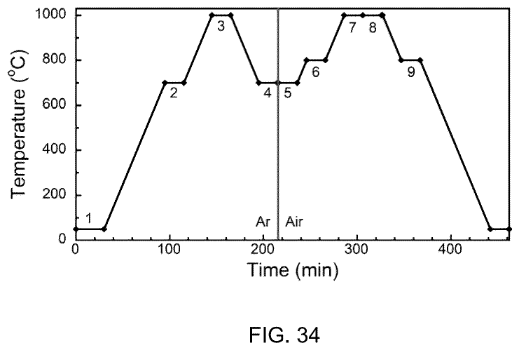

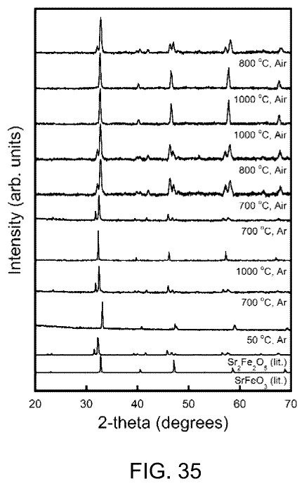

Sr_{0.75}Ca_{0.25}FeO₃ and Sr_{0.7}Ca_{0.3}FeO₃ materials when oxidized past 850° C. showed some peculiar behavior. At this temperature, the mass of the materials increases even after nearly reaching full reduction in the case of Sr_{0.7}Ca_{0.3}FeO₃. This temperature range aligns with the unexpected decrease in oxygen storage capacity for the SCF30 series at higher synthesis temperatures discussed above. In situ pXRD using a heating profile shown in FIG. 34 was implemented to simulate these experiments to determine what structural changes occur past this point. Analysis of SCF30-SSR can be found in FIG. 35, with patterns collected at select points during treatment using argon and air. Distinct crystallographic changes were observed through the course of the experiment. Initially, at room temperature, the material is pure SrFeO₃-like perovskite, and it changes to a brownmillerite structure between 700 and 800° C. under both Ar and Air. This aligns well with the baseline reduction seen in the thermogravimetric analysis. Under both atmospheres at 1000° C., the material appears to adopt perovskite structure again. However, this phenomenon has been well-explained in the SrFeO₃ literature as lost symmetry through brownmillerite distortions. From thermogravimetric analysis, it has been shown that this deformed structure adsorbs oxygen significantly better than the brownmillerite structure.

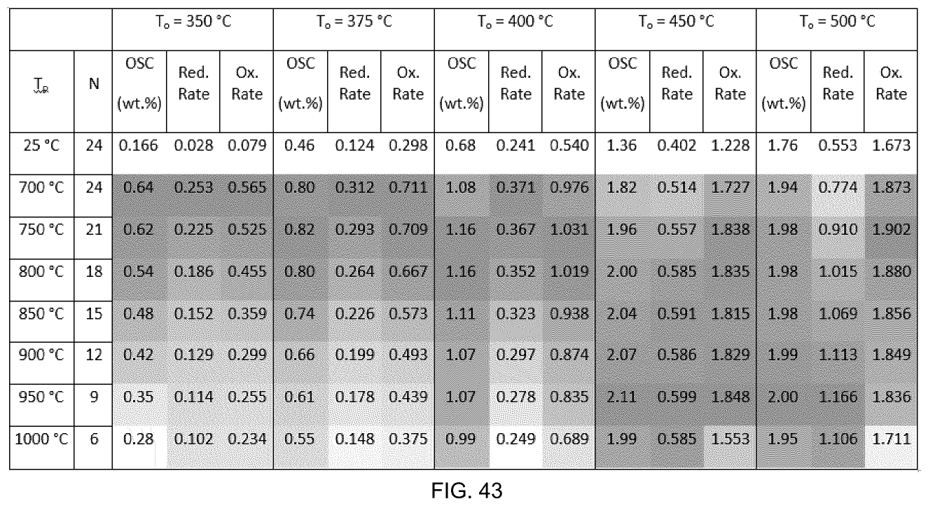

The table shown in FIG. 43 displays the average values for the oxygen storage capacity, reduction rates, and oxidation rates of the sampling range used herein for experiments involving the invented mesoporous perovskite oxygen carriers. Pretreatment with N₂ at an elevated temperature is necessary as the materials with Tₚ=700-1000° C. outperform the untreated materials by demonstrating higher OSC and reduction/oxidation rates at all operating temperatures between 350 and 500° C. The table of data shown in FIG. 43, shows trends in operating temperatures below 400° C., as the Tₚ=700, 750, and 800° C. outperform the higher Tₚ in both storage capacity and reduction rate. This is reversed at Tₒ=450 and 500° C. as the higher Tₚ materials perform similarly or better than the lower Tₚ materials. However, the total number of data points, N, included at each pretreatment temperature is variable. As shown in TABLES 6-8, the best performing materials at operating temperatures below 400° C. had Tₛ at approximately 800-850° C. Since these materials are only reported in the averages for Tₚ≤850° C., an artificial decline occurs. Additionally, because higher synthesis temperatures are preferred when operating at 450 and 500° C., these materials are overrepresented in the averages reported for the higher pretreatment temperatures.

TABLE 6
Best performing materials at 350° C.

| | | | | | |
|---|---|---|---|---|---|
| | | | | Red. | Ox. |
| | | | | Rate | Rate |
| | Tₛ | Tₚ | OSC | (wt. %/ | (wt. %/ |
| Composition | (° C.) | (° C.) | (wt. %) | min) | min) |

Top OSC Materials

| | | | | | |
|---|---|---|---|---|---|
| Sr_{0.7}Ca_{0.3}FeO₃ | 800 | 800 | 1.234 | 0.434 | 1.179 |
| Sr_{0.7}Ca_{0.3}FeO₃ | 850 | 850 | 1.159 | 0.365 | 0.891 |
| Sr_{0.7}Ca_{0.3}FeO₃ | 850 | 800 | 1.134 | 0.406 | 0.968 |
| Sr_{0.7}Ca_{0.3}FeO₃ | 750 | 750 | 1.114 | 0.424 | 0.965 |
| Sr_{0.7}Ca_{0.3}FeO₃ | 850 | 750 | 1.104 | 0.451 | 1.075 |

Top Reduction Rate Materials

| | | | | | |
|---|---|---|---|---|---|
| Sr_{0.7}Ca_{0.3}FeO₃ | 750 | 750 | 1.114 | 0.451 | 1.075 |
| Sr_{0.7}Ca_{0.3}FeO₃ | 850 | 700 | 1.082 | 0.440 | 0.965 |
| Sr_{0.7}Ca_{0.3}FeO₃ | 800 | 800 | 1.234 | 0.434 | 1.179 |
| Sr_{0.7}Ca_{0.3}FeO₃ | 700 | 700 | 0.913 | 0.424 | 0.882 |
| Sr_{0.7}Ca_{0.3}FeO₃ | 850 | 750 | 1.104 | 0.424 | 0.965 |

TABLE 7
Best performing materials at 375° C.

| | | | | | |
|---|---|---|---|---|---|
| | | | | Red. | Ox. |
| | | | | Rate | Rate |
| | Tₛ | Tₚ | OSC | (wt. %/ | (wt. %/ |
| Composition | (° C.) | (° C.) | (wt. %) | min) | min) |

Top OSC Materials

| | | | | | |
|---|---|---|---|---|---|
| Sr_{0.7}Ca_{0.3}FeO₃ | 800 | 800 | 1.702 | 0.555 | 1.605 |
| Sr_{0.7}Ca_{0.3}FeO₃ | 850 | 850 | 1.689 | 0.526 | 1.413 |
| Sr_{0.7}Ca_{0.3}FeO₃ | 850 | 800 | 1.505 | 0.543 | 1.356 |
| Sr_{0.7}Ca_{0.3}FeO₃ | 800 | 750 | 1.415 | 0.499 | 1.337 |
| Sr_{0.7}Ca_{0.3}FeO₃ | 750 | 750 | 1.403 | 0.511 | 1.329 |

Top Reduction Rate Materials

| | | | | | |
|---|---|---|---|---|---|
| Sr_{0.7}Ca_{0.3}FeO₃ | 850 | 700 | 1.297 | 0.562 | 1.199 |
| Sr_{0.7}Ca_{0.3}FeO₃ | 800 | 800 | 1.702 | 0.555 | 1.605 |
| Sr_{0.7}Ca_{0.3}FeO₃ | 850 | 750 | 1.377 | 0.548 | 1.262 |
| Sr_{0.7}Ca_{0.3}FeO₃ | 850 | 800 | 1.505 | 0.543 | 1.356 |
| Sr_{0.7}Ca_{0.3}FeO₃ | 850 | 850 | 1.689 | 0.526 | 1.413 |

TABLE 8
Best performing materials at 400° C.

| | | | | | |
|---|---|---|---|---|---|
| | | | | Red. | Ox. |
| | | | | Rate | Rate |
| | Tₛ | Tₚ | OSC | (wt. %/ | (wt. %/ |
| Composition | (° C.) | (° C.) | (wt. %) | min) | min) |

Top OSC Materials

| | | | | | |
|---|---|---|---|---|---|
| Sr_{0.7}Ca_{0.3}FeO₃ | 800 | 800 | 2.07 | 0.670 | 1.987 |
| Sr_{0.7}Ca_{0.3}FeO₃ | 850 | 850 | 2.04 | 0.715 | 1.890 |
| Sr_{0.7}Ca_{0.3}FeO₃ | 850 | 800 | 1.90 | 0.656 | 1.792 |
| Sr_{0.7}Ca_{0.3}FeO₃ | 800 | 750 | 1.85 | 0.573 | 1.759 |
| Sr_{0.7}Ca_{0.3}FeO₃ | 900 | 900 | 1.76 | 0.542 | 1.550 |

Top Reduction Rate Materials

| | | | | | |
|---|---|---|---|---|---|
| Sr_{0.7}Ca_{0.3}FeO₃ | 850 | 850 | 2.04 | 0.715 | 1.890 |
| Sr_{0.7}Ca_{0.3}FeO₃ | 800 | 800 | 2.07 | 0.670 | 1.987 |
| Sr_{0.7}Ca_{0.3}FeO₃ | 850 | 800 | 1.90 | 0.656 | 1.792 |
| Sr_{0.7}Ca_{0.3}FeO₃ | 850 | 750 | 1.74 | 0.629 | 1.640 |
| Sr_{0.7}Ca_{0.3}FeO₃ | 850 | 700 | 1.61 | 0.616 | 1.515 |

TABLE 9
Best performing materials at 450° C.

| | | | | | |
|---|---|---|---|---|---|
| | | | | Red. | Ox. |
| | | | | Rate | Rate |
| | Tₛ | Tₚ | OSC | (wt. %/ | (wt. %/ |
| Composition | (° C.) | (° C.) | (wt. %) | min) | min) |

Top OSC Materials

| | | | | | |
|---|---|---|---|---|---|
| Sr_{0.75}Ca_{0.25}FeO₃ | 1000 | 950 | 2.43 | 0.637 | 2.324 |
| Sr_{0.75}Ca_{0.25}FeO₃ | 950 | 950 | 2.42 | 0.700 | 2.336 |
| Sr_{0.75}Ca_{0.25}FeO₃ | 1000 | 900 | 2.42 | 0.579 | 2.251 |
| Sr_{0.75}Ca_{0.25}FeO₃ | 1000 | 1000 | 2.41 | 0.734 | 2.277 |
| Sr_{0.75}Ca_{0.25}FeO₃ | 950 | 900 | 2.40 | 0.638 | 2.311 |

Top Reduction Rate Materials

| | | | | | |
|---|---|---|---|---|---|
| Sr_{0.7}Ca_{0.3}FeO₃ | 850 | 850 | 1.72 | 1.116 | 1.653 |
| Sr_{0.7}Ca_{0.3}FeO₃ | 1100 | 700 | 2.22 | 0.984 | 1.897 |
| Sr_{0.7}Ca_{0.3}FeO₃ | 800 | 800 | 1.86 | 0.940 | 1.793 |
| Sr_{0.7}Ca_{0.3}FeO₃ | 1100 | 750 | 2.23 | 0.925 | 1.760 |
| Sr_{0.7}Ca_{0.3}FeO₃ | 900 | 900 | 1.57 | 0.899 | 1.512 |

TABLE 10
Best performing materials at 500° C.

| | | | | | |
|---|---|---|---|---|---|
| | | | | Red. | Ox. |
| | | | | Rate | Rate |
| | Tₛ | Tₚ | OSC | (wt. %/ | (wt. %/ |
| Composition | (° C.) | (° C.) | (wt. %) | min) | min) |

Top OSC Materials

| | | | | | |
|---|---|---|---|---|---|
| Sr_{0.8}Ca_{0.2}FeO₃ | 950 | 950 | 2.32 | 0.693 | 2.252 |
| Sr_{0.8}Ca_{0.2}FeO₃ | 950 | 900 | 2.31 | 0.666 | 2.252 |
| Sr_{0.8}Ca_{0.2}FeO₃ | 950 | 850 | 2.31 | 0.627 | 2.251 |
| Sr_{0.8}Ca_{0.2}FeO₃ | 950 | 800 | 2.31 | 0.586 | 2.248 |
| Sr_{0.8}Ca_{0.2}FeO₃ | 950 | 750 | 2.31 | 0.546 | 2.243 |

Top Reduction Rate Materials

| | | | | | |
|---|---|---|---|---|---|
| Sr_{0.75}Ca_{0.25}FeO₃ | 1000 | 1000 | 2.18 | 1.697 | 2.104 |
| Sr_{0.75}Ca_{0.25}FeO₃ | 950 | 950 | 2.20 | 1.630 | 2.129 |
| Sr_{0.7}Ca_{0.3}FeO₃ | 1100 | 750 | 1.76 | 1.565 | 1.344 |
| Sr_{0.75}Ca_{0.25}FeO₃ | 1000 | 950 | 2.21 | 1.557 | 2.144 |
| Sr_{0.7}Ca_{0.3}FeO₃ | 1100 | 700 | 1.76 | 1.546 | 1.452 |

Due to these inconsistencies in the averages, identifying the specific best performing materials for each operating temperature allows for better analysis of the trends. Starting at an operating temperature of 350° C., the maximum oxygen storage capacities achieved by SCF30-800-P800, SCF30-850-P850, SCF30-850-P800, SCF30-750-750, and SCF30-850-P750 were 1.23, 1.16, 1.13, 1.11, and 1.10 wt. %, respectively. A similar selection of materials was found to have the fastest initial reduction rate at this temperature. SCF30-750-P750, SCF30-850-P700, SCF30-800-P800, SCF30-700-P700, and SCF30-850-P750 had reduction rates of 0.45, 0.44, 0.43, 0.42, and 0.42 wt. %/min, respectively. Oxidation rates for all the listed materials were rapid, with roughly 80-95% of maximum oxygen uptake occurring within the first minute. Therefore, the three materials with the most rapid kinetics and highest oxygen storage capacities are SCF30-800-P800, SCF30-850-P750, and SCF30-750-P750. Unsurprisingly, these materials have the maximum calcium content at 30% and the highest BET surface areas (2.32-5.32 m²/g).

Increasing the operating temperature to 375° C. has similar results to the experiments at 350° C. (data shown in TABLE 7). The maximum oxygen storage capacities were 1.70, 1.69, 1.51, 1.42, and 1.40 wt. % using SCF30-800-P800, SCF30-850-P850, SCF30-850-P800, SCF30-800-P750, and SCF30-750-P750. Four of these materials are the same as the top materials at 350° C., with SCF30-850-700 as the lone exception (6^{th} highest OSC at 350° C.). The highest reduction rates of 0.56, 0.56, 0.55, 0.54, and 0.53 wt. %/min were reached by SCF30-850-P700, SCF30-800-P800, SCF30-850-P750, SCF30-850-P800, and SCF30-850-P850. As previously observed at 350° C., agreement with three of the top storage capacities and reduction rates: SCF30-800-P800, SCF30-850-P750, and SCF30-850-P850 was observed.

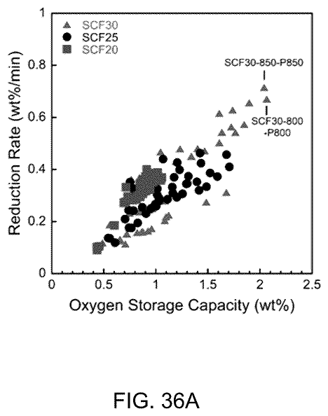

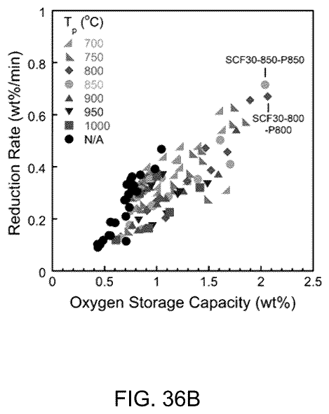

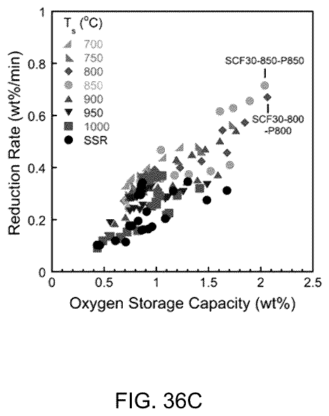

At 400° C., w the same collection of materials were observed attaining the highest storage capacities and reduction kinetics. To visualize the individual roles of composition, synthesis temperature, and pretreatment temperature, storage capacity vs. reduction rate plots are provided in FIGS. 36A-36C. While both calcium content and synthesis temperature were observed highly important, pretreatment temperature plays a more complimentary role. In addition, the first two materials identified in this analysis to break a threshold oxygen storage capacity of 2.00 wt. % in 10-minute redox cycles. Both SCF30-800-P800 (2.07 wt. %) and SCF30-850-P850 (2.04 wt. %) were also top materials at Tₒ=350 and 375° C. as well. The other three materials with the highest oxygen storage capacities were SCF30-850-P800, SCF30-800-P750, and SCF30-900-P900 at 1.90, 1.85, and 1.76 wt. %. The highest reduction rates are dominated by the SCF30-850 material, with only SCF30-800-P800 being an outlier. These highest rates range from 0.72 to 0.62 wt. %/min with the SCF30-850-P850 being the fastest and SCF30-800-P800 second.

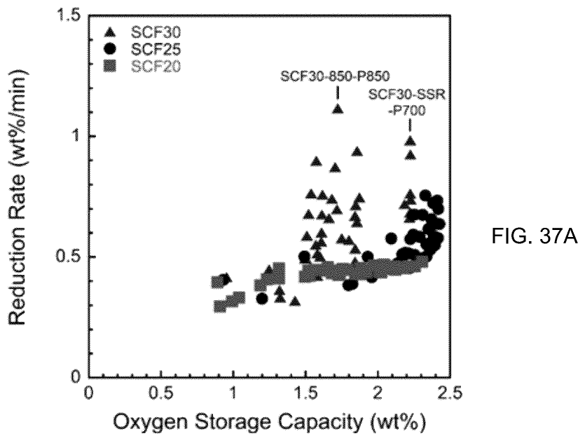

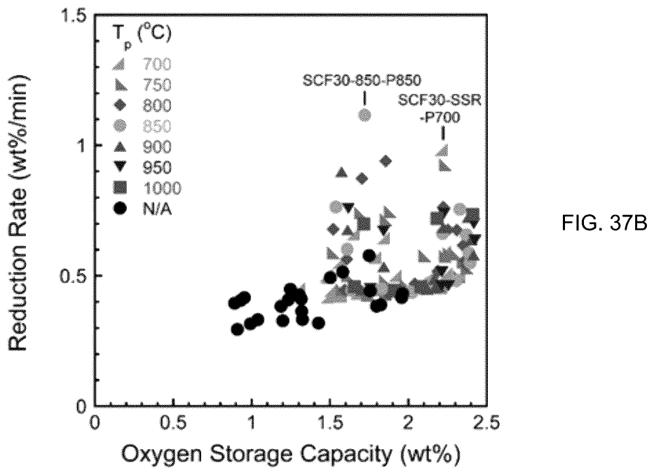

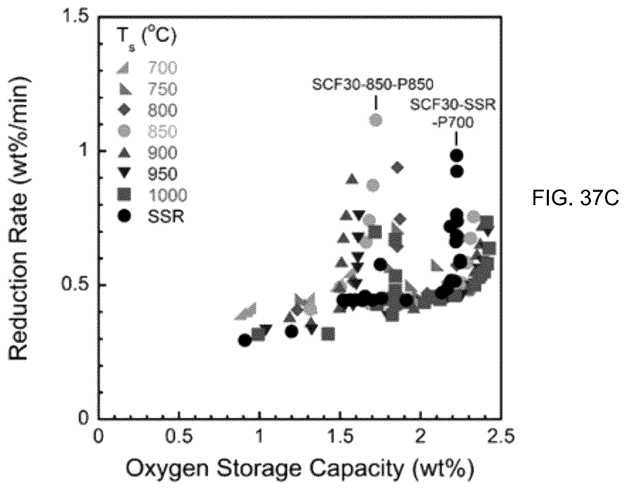

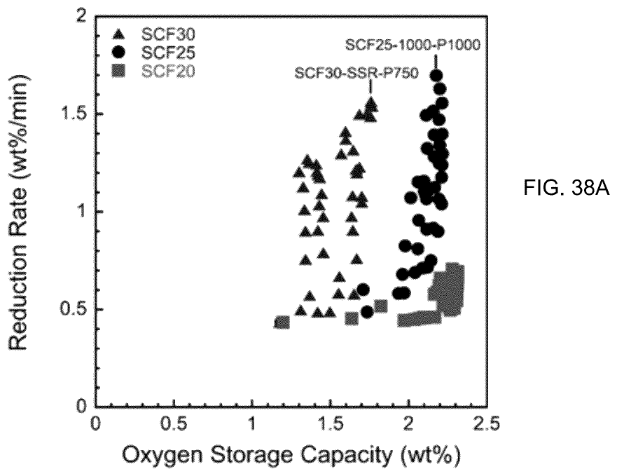

When the operating temperature reaches 450° C., unlike the previous three temperatures, the materials with the highest oxygen storage capacities do not have the fastest reduction rates (FIGS. 37A-37C). In fact, the five materials with the fastest reduction rates are SCF30-850-P850 (1.12 wt. %/min), SCF30-1100-P700 (0.98 wt. %/min), SCF30-800-P800 (0.94 wt. %/min), SCF30-1100-P750 (0.93 wt. %/min), and SCF30-900-P900 (0.90 wt. %/min). The pretreatment temperature significantly alters the reduction rate for the active SCF30 materials, including SCF30-SSR, without changing the storage capacity. However, the materials with the highest 10-minute oxygen storage capacities are all Sr0.75Ca0.25FeO3-based, with SCF25-1000 and SCF25-950 taking the top five positions with pretreatment between 900° C. and 1000° C. The maximum oxygen storage capacity of 2.43 wt. % was achieved by SCF25-1000-P950. To emphasize the disconnection between the fastest reduction rates and the largest storage capacities, SCF30-850-P850 ranks 83rd with a total storage capacity of 1.72 wt. %, whereas the top SCF25-1000-P1000 material ranks 14th in reduction rate at 0.73 wt. %/min. At the operating temperature of 450° C., optimal elemental composition becomes more important than large surface area as bulk-like materials are among the best-performing materials.

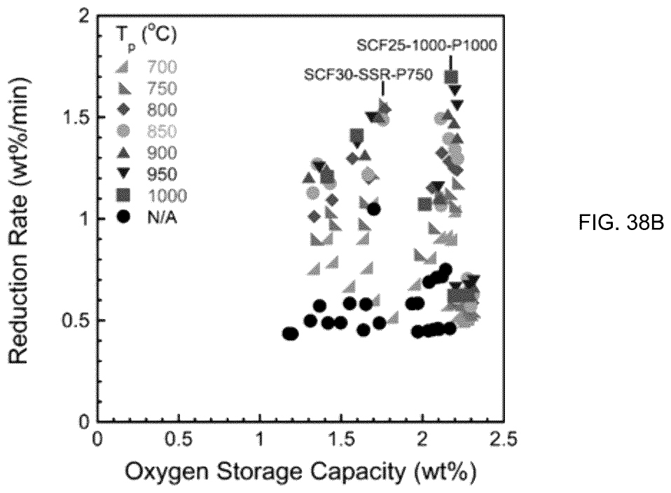

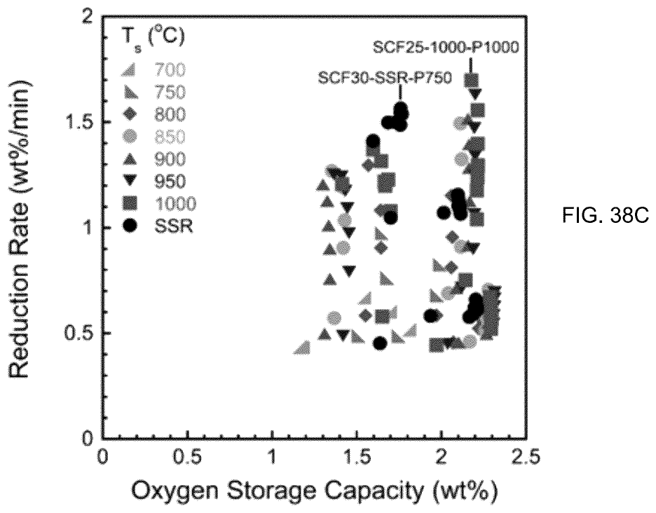

A similar outcome is found at Tₒ=500° C. as well, but with a greater disparity in reduction rates between materials. The SCF20-950 series has the five highest oxygen storage capacities tested, aligning with a sequential decrease in pretreatment temperatures from 950° C. to 750° C. (FIGS. 38A-38C, TABLE 10). Each of these five experiments had a storage capacity of 2.31-2.32 wt. %. The fastest reduction rates were achieved by low surface area Sr_{0.7}Ca_{0.3}FeO₃ and Sr_{0.75}Ca_{0.25}FeO₃ materials, but the top Sr_{0.8}Ca_{0.2}FeO₃ material was the 72^{nd} fastest (0.71 wt. %/min). The maximum reduction rate is 1.70 wt. %/min using SCF25-1000-P1000, with a 10-min storage capacity of 2.18 wt. %. The next four fastest reduction rates were all above 1.55 wt. %/min by SCF25-950-P950, SCF30-1100-P750, SCF25-1000-P950, and SCF30-1100-P700. At this operating temperature, a noticeable difference was also observed between the storage capacity and oxidation rate, as the Sr_{0.7}Ca_{0.3}FeO₃ materials have uptake less than 80% of the cycled oxygen within the first minute. Unlike at lower operating temperatures, where the upper limit of calcium incorporation was reached and higher surface areas are preferred, bulk-like materials with high calcium contents are preferred at higher temperatures.

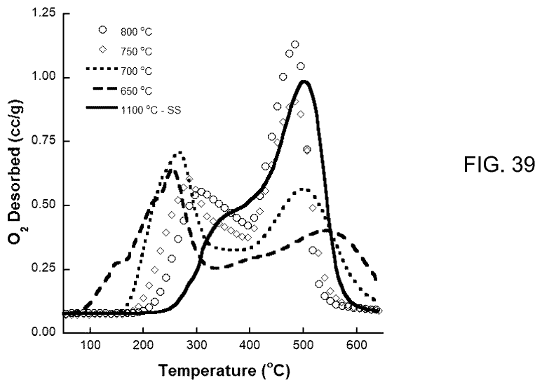

The increased surface area of oxygen carriers synthesized using the invented method determined visually and confirmed by BET measurements, leads to distinctly different thermodynamic and kinetic properties for the material. Oxygen temperature programmed desorption illustrates the change in the thermodynamics of oxygen release that are afforded by this change. These results can be seen in FIG. 39 for a variety of synthesis temperatures starting with Sr_{0.8}Ca_{0.2}FeO₃ as an example of temperature dependence. Shown here, the thermodynamics of oxygen release can be greatly reduced due to this change, with onset and maximum desorption temperature changes of over 200° C. and 100° C., respectively for the samples made at 650° C.

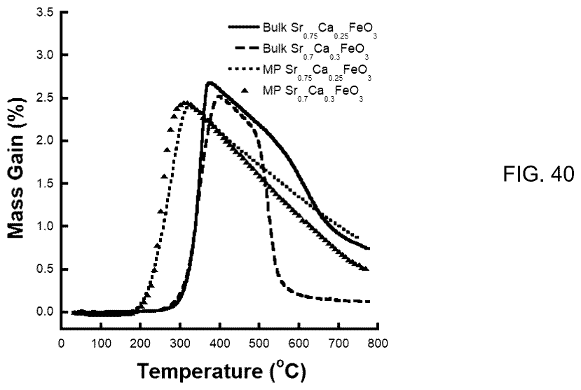

As shown in FIG. 40, mesoporous materials made by the invented method have decreased thermodynamic and/or kinetic barriers causing oxygen uptake at significantly lower temperatures. As shown in FIG. 40, for a sample of Sr_{0.75}Ca_{0.25}FeO₃ in two different morphologies, difference of 50° C. in peak storage temperature and 80° C. in oxidation onset temperature are important to the ensuring the materials are oxidized as quickly as possible. The difference is similar for Sr_{0.7}Ca_{0.3}FeO₃ materials, with a difference of 90° C. in peak storage temperature and 70° C. in onset temperature.

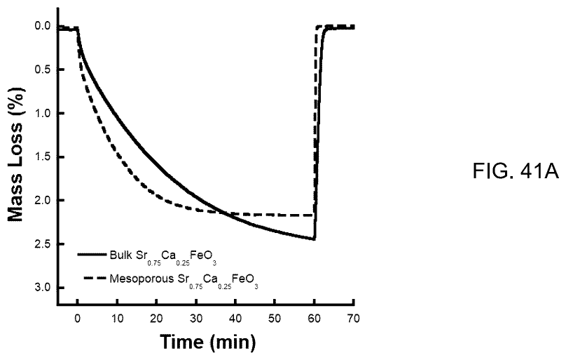

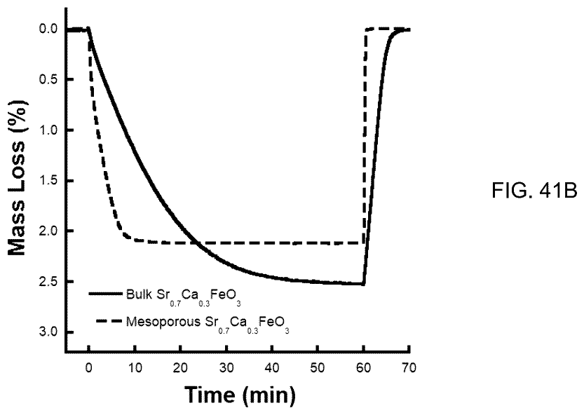

Kinetics of oxygen carriers made using the invented method can be seen in FIGS. 41A-41B, which is a thermogravimetric analysis trace of materials made using the invented method, at a synthesis temperature of 800° C. or the bulk material synthesized at 1100° C., being cycled between air and nitrogen at the low temperature of 400° C. In fact, both sets of Sr₁₋ₓCaₓFeO₃ samples show increased kinetics. For processes that require short time windows for uptake and release, these materials are ideal. Specifically, the mesoporous Sr_{0.7}Ca_{0.3}FeO₃ can release its full 2.1 wt. % O₂ in 8 minutes, whereas the bulk material requires 23 minutes for the same amount of O₂. The reoxidation is also much faster, 1 minute compared to >3 minutes. For a given period in an air separation unit, this suggests that 200% more oxygen could be produced by the mesoporous material at 400° C. than the bulk sample. This is seen on a lesser scale for the Sr_{0.75}Ca_{0.25}FeO₃ material, requiring 30 and 38 minutes for an O₂ release of 2.1 wt % at 400° C. for the mesoporous and bulk materials, respectively. This would lead to 27% more oxygen over a period in an air separation unit using materials made using the invented method.

In the embodiment, the invention provides a perovskite oxygen carrier comprising the formula SrFeO₃, wherein the oxygen carrier comprises an A-site and a B-Site, and wherein the B-site is doped with Ni.

In an embodiment, the invention provides a perovskite oxygen carrier comprising the formula Sr₁₋ₓCaₓFe_{1-y}Ni_{y}O₃, where 0.05<x<0.30 and 0.001<y<0.125.

In an embodiment, the invention provides a method for carrying oxygen using a perovskite oxygen carrier, the method comprising: providing a reduced oxygen carrier to a reaction environment; contacting the reduced oxygen carrier with an oxygen containing gaseous stream for a predetermined time at a first temperature and a first oxygen partial pressure, wherein the reduced oxygen carrier adsorbs oxygen from the gaseous stream during this step, giving an oxygen carrier; and heating the oxygen carrier to a second temperature at a second oxygen partial pressure, causing oxygen adsorbed onto the oxygen carrier in the contacting step to be released from the oxygen carrier, reforming the reduced oxygen carrier, wherein the oxygen carrier comprises the formula Sr₁₋ₓCaₓFe_{1-y}Ni_{y}O₃, where 0.05<x<0.30 and 0.001<y<0.125. In an embodiment, during the contacting step, the reduced oxygen carrier adsorbs between approximately 1.50 wt % and approximately 3 wt % of oxygen. In an embodiment, during the contacting step, the reduced oxygen carrier adsorbs at least 2.00 wt % oxygen. In an embodiment, the reduced oxygen carrier has a maximum adsorption temperature between approximately 573° K. and approximately 673° K. In an embodiment, the reduced oxygen carrier is oxidized at a rate between approximately 2.00 wt %/min and approximately 10.00 wt %/min during the contacting step. In an embodiment, the oxygen carrier is reduced at a rate between approximately 0.033 wt %/min and approximately 1.5 wt %/min during the heating step. In an embodiment, the oxygen carrier has a desorption onset temperature between approximately 473° K. and approximately 523° K. In an embodiment, the oxygen carrier has a maximum desorption temperature between approximately 673° K. and approximately 773° K.

In an embodiment, the invention provides a perovskite oxygen carrier comprising the formula SrCaFeO₃, wherein the oxygen carrier is mesoporous. In an embodiment, the oxygen carrier comprises the formula Sr₁₋ₓCaₓFeO₃, where 0.01<x<0.40. In an embodiment, the oxygen carrier comprises a network of nanoparticles sintered together. In an embodiment, the perovskite oxygen carrier has a surface area between approximately 2.3 m²/g and approximately 9 m²/g.

In an embodiment, the invention provides a method for carrying oxygen using a perovskite oxygen carrier, the method comprising: providing a reduced oxygen carrier to a reaction environment; contacting the reduced oxygen carrier with an oxygen containing gaseous stream for a predetermined time at a first temperature and a first oxygen partial pressure, wherein the reduced oxygen carrier adsorbs oxygen from the gaseous stream during this step, giving an oxygen carrier; and heating the oxygen carrier to a second temperature at a second oxygen partial pressure, causing oxygen adsorbed onto the oxygen carrier in the contacting step to be released from the oxygen carrier, reforming the reduced oxygen carrier, wherein the oxygen carrier comprises the formula Sr₁₋ₓCaₓFeO₃, where 0.01<x<0.40, and wherein said oxygen carrier is mesoporous. In an embodiment, the oxygen carrier has a surface area between approximately 2.3 m²/g and approximately 9 m²/g. In an embodiment, the reduced oxygen carrier adsorbs between approximately 2.00 wt % and approximately 3.00 wt % of oxygen. In an embodiment, the reduced oxygen carrier adsorbs at least 2.00 wt % oxygen. In an embodiment the reduced oxygen carrier has a maximum adsorption temperature between approximately 473° K. and approximately 673° K. In an embodiment, the reduced oxygen carrier is oxidized at a rate between approximately 0.08 wt %/min and approximately 2.24 wt %/min during the contacting step. In an embodiment, the oxygen carrier is reduced at a rate between approximately 0.03 wt %/min and approximately 1.55 wt %/min during the heating step. In an embodiment, the oxygen carrier has a desorption onset temperature between approximately 313° K. and approximately 573° K. In an embodiment, the oxygen carrier has a maximum desorption temperature between approximately 473° K. and approximately 773° K.

In an embodiment, the invention provides a method for making mesoporous perovskite oxygen carriers comprising: producing polymerized metal-carboxylate chelates; calcining the polymerized metal-carboxylate chelates at a synthesis temperature to produce the mesoporous perovskite oxygen carriers, wherein the synthesis temperature is below 1000° C. In an embodiment, the mesoporous oxygen carriers comprise the general formula Sr₁₋ₓCaₓFeO₃, where 0.01<x<0.40. In an embodiment, the synthesis temperature is between approximately 650° C. and approximately 850° C. In an embodiment, the mesoporous oxygen carriers comprise a surface area between approximately 2.3 m²/g and approximately 9 m²/g.

A person having ordinary skill in the art will readily understand that temperatures given in ° C. and ° K. are readily convertible from one to the other according to standard convention where a measurement given in ° C. can be converted to ° K. by adding 273.15, and a measurement given in ° K. can be converted to ° C. by subtracting 273.15.

It is to be understood that the above-described arrangements are only illustrative of the application of the principles of the present invention. Numerous modifications and alternative arrangements may be devised by those skilled in the art without departing from the spirit and scope of the present invention and the appended claims are intended to cover such modifications and arrangements.

The recitation of numerical ranges by endpoints includes all numbers and subranges within that range (e.g. 1 to 5 includes 1, 1.5, 2, 2.75, 3, 3.80, 4, 5, and 2 to 4).

Any element in a claim that does not explicitly state “means for” performing a specified function, or “step for” performing a specific function, is not to be interpreted as a “means” or “step” clause as specified in 35 U.S.C. § 112, ¶ 6. In particular, the use of “step of” in the claims herein is not intended to invoke the provisions of 35 U.S.C. § 112, ¶ 6.

What is claimed is:

1. A perovskite oxygen carrier comprising the formula SrFeO₃, wherein the oxygen carrier comprises an A-site and a B-Site, and wherein the B-site is doped with Ni.

2. A perovskite oxygen carrier comprising the formula Sr₁₋ₓCaₓFe_{1-y}Ni_{y}O₃, where 0.05<x<0.30 and 0.001<y<0.125.

3. A method for carrying oxygen using a perovskite oxygen carrier, the method comprising:
providing a reduced oxygen carrier to a reaction environment;
contacting the reduced oxygen carrier with an oxygen containing gaseous stream for a predetermined time at a first temperature and a first oxygen partial pressure, wherein the reduced oxygen carrier adsorbs oxygen from the gaseous stream during this step, giving an oxygen carrier; and
heating the oxygen carrier to a second temperature at a second oxygen partial pressure, causing oxygen adsorbed onto the oxygen carrier in the contacting step to be released from the oxygen carrier, reforming the reduced oxygen carrier, wherein the oxygen carrier comprises the formula Sr₁₋ₓCaₓFe_{1-y}Ni_{y}O₃, where 0.05<x<0.30 and 0.001<y<0.125.

4. The method of claim 3 wherein, during the contacting step, the reduced oxygen carrier adsorbs between approximately 1.50 wt % and approximately 3 wt % of oxygen.

5. The method of claim 3 wherein, during the contacting step, the reduced oxygen carrier adsorbs at least 2.00 wt % oxygen.

6. The method of claim 3 wherein the reduced oxygen carrier has a maximum adsorption temperature between approximately 573° K. and approximately 673° K.

7. The method of claim 3 wherein the reduced oxygen carrier is oxidized at a rate between approximately 2.00 wt %/min and approximately 10.00 wt %/min during the contacting step.

8. The method of claim 3 wherein the oxygen carrier is reduced at a rate between approximately 0.033 wt %/min and approximately 1.5 wt %/min during the heating step.

9. The method of claim 3 wherein the oxygen carrier has a desorption onset temperature between approximately 473° K. and approximately 523° K.

10. The method of claim 3 wherein the oxygen carrier has a maximum desorption temperature between approximately 673° K. and approximately 773° K.
